(19) United States
(12) Patent Application Publication
(10) Pub. No.: US 2013/0124974 A1
(43) Pub. Date: May 16, 2013

(54) System for Assembling Webpage's Region of Other Website into a Webpage of a Website and Method for the Same

(71) Applicants: Seung June Song, Seoul (KR); Seung Ik Lee, Seoul (KR); Jong Su Kim, Seoul (KR); Sang Heon Lee, Gyeonggi-do (KR)

(72) Inventors: Seung June Song, Seoul (KR); Seung Ik Lee, Seoul (KR); Jong Su Kim, Seoul (KR); Sang Heon Lee, Gyeonggi-do (KR)

(21) Appl. No.: 13/698,387

(22) PCT Filed: May 18, 2011
(86) PCT No.: PCT/KR11/03689

§ 371 Date: Jan. 28, 2013

(30) Foreign Application Priority Data
May 19, 2010 (KR) 10-2010-0047109
Jun. 30, 2010 (KR) 10-2010-0062823

(51) Int. Cl. G06F 17/21

(52) U.S. Cl. CPC G06F 17/21
USPC 715/234

(57) ABSTRACT

According to the present invention, a method for assembling sections of web pages of websites comprises: enabling a section to be set on a webpage of an object website (200) displayed on a user computer (500) (step S41); enabling a device (50) for providing a website-section-assembling service, which is installed on the user computer (500), to read the positional value of the section and the URL of the webpage of the object website (200), and transmit the read value and URL to a website-section-assembling server (100) (step S42); enabling the website-section-assembling server (100) to store the received value and URL (step S43); enabling the user computer (500) to access a target website (300) and set a point at which the section of the webpage of the object website (200) is to be displayed, and then enabling the device (50) for providing a website-section-assembling service to read the URL of the webpage of the target website (300) and a target positional value and transmit the read URL and value to the website-section-assembling server (100) (step S45); enabling the website-section-assembling server (100) to store the received value and URL (Step S46); enabling the user computer (500) to access the target website (300) (step S47); enabling the user computer (500) to make a request for information on the section at the website-section-assembling server (100) (step S48); and enabling the website-section-assembling server (100) to transmit relevant values to the user computer, and then enabling the device (50) for providing a website-section-assembling service to read the relevant values and display the section of the webpage of the object website (200) at the target point on the webpage (step S49).

### BACKGROUND OF THE INVENTION

The present invention relates to a system and method for assembling a section of webpage of a website, and more specifically, the system and method for assembling a section of webpage of a website where a user assembles a section of a web pages of a website into an output display of a webpage of another website so that the assembled section is displayed as if it is the original webpage section of the website.

Desires of users in relation to websites are different from person to person, and such diverse personal desires cannot be satisfied in one website. For this reason, a lot of Internet users connect to a plurality of websites at his or her computer, open all these websites and use them moving one by one according to the desires. However, it causes inconvenience such as opening and closing browser windows and moving to a desired website.

Although a multi-tab function is supported currently to simultaneously open a plurality of pages in one browser, it is not easy to view desired contents at a glance because the user should click the tabs one by one and confirm the page.

The solution to this problem is to allow individual users to assemble desired webpage sections of desired websites in one website and use the assembled.

That is, a user assembles sections of different websites which the user wants into an output display of other website so that they operates as if they are originally one part of the webpage of the other website.

For example, when a user who frequently uses a specific on-line shopping mall wants to know information about the current stock market situation or to use a message transmission service, the section of the stock market situation in the output webpage of the website for the stock market situation is shown on the screen of the on-line shopping mall website and operates therein, or the section of the message transmission in the output webpage of the website for the message transmission service is shown on the screen of the on-line shopping mall website and operates therein. The present invention satisfies such a demand.

### SUMMARY OF THE INVENTION

The purpose of the present invention is to provide is to provide a system and method for assembling a section of webpage of a website where a user can assemble sections of different websites which the user wants into an output display of other website so that they operates as if they are originally one part of the webpage of the other website.

To accomplish the above object, according to one aspect of the present invention, in a website-section assembling system including a utilization website of which a section of a webpage is desired to be utilized by a user, a target website on an output display of a webpage of which the section of the webpage of the utilization website is desired to be outputted as it is assembled, a user computer having a web browser and a website-section assembling apparatus, and a website-section assembling server, there is provided a method for assembling the section of the webpage of the utilization website on the output display of the webpage of the target website comprising: a utilization-section information transmission step wherein if a utilization-section that is the section of the webpage of the utilization website desired to be utilized is established by means of an input device on the display of the webpage of the utilization website outputted when the user computer connects to the utilization website, the website-section assembling apparatus or the web browser reads utilization URL that is the URL of the webpage of the utilization website and position value of the established utilization-section and transmits the utilization URL and the position value to the website-section assembling server; a utilization-section information store step wherein the website-section assembling server receives the utilization-section information and stores it; a utilization-section information request step wherein the user computer connects to the target website and the website-section assembling apparatus in the user computer requests the utilization-section information to the website-section assembling server; and a utilization-section output step wherein the website-section assembling apparatus reads the utilization-section information and outputs the utilization-section of the webpage of the utilization website on the output display of the webpage of the target website if the website-section assembling server transmits the utilization-section information to the user computer according to the utilization-section information request.

According to the invention, it is preferable that a target position that is a position where the utilization-section is desired to be outputted is set by means of the input device on the display of the webpage outputted when the user computer connects to the target website, and the website-section assembling apparatus reads target position value and outputs the utilization-section at the target position.

According to the invention, it is preferable that the utilization-section is outputted at a position corresponding to the position value previously set in the website-section assembling apparatus or the website-section assembling server or at a randomly selected position, and the outputted utilization-section can be moved by handling the input device of the user computer.

In this case, it is preferable that the outputted utilization-section is moved to a position desired by the user on the output display of the target website by dragging a mouse connected to the user computer.

According to the invention, in the utilization-section output step, the website-section assembling apparatus may create a layer at the output position of the utilization-section on the outputted webpage of the target website and inject the utilization URL into the layer so that the utilization URL may be called.

In this case, it is preferable that the layer is created to have a size of the utilization-section, and a webpage corresponding to the utilization URL is outputted on the layer created at the position of the utilization-section on the webpage of the target website.

According to an embodiment of the invention, it is preferable that in the utilization-section output step, the website-section assembling apparatus creates the layer having a size of the utilization-section at the output position of the utilization-section on the webpage of the target website using a div tag and injects an iframe tag into the layer so that the utilization URL may be called, and at this point, a position of a scroll bar on a webpage corresponding to the URL called by the iframe is set to a top-left coordinate value contained in the utilization-section position value.

In addition, in this case, it is preferable that VISUAL among attributes of the scroll bar is set to NO so that the scroll bar may not be shown from outside.

According to the invention, the website-section assembling apparatus and the web browser installed in the user computer may be integrated into one piece.

According to the invention, it is preferable that the utilization-section output step creates a new window at the output position of the utilization-section on the output display of the webpage of the target website, outputs the web browser in the new window, and calls the utilization URL so that a screen of the utilization URL is outputted in the web browser.

According to the invention, it is preferable that in the utilization-section output step, the website-section assembling apparatus selectively performs a step of creating a new window at the output position of the utilization-section on the output display of the webpage of the target website, outputting the web browser in the new window, and calling the utilization URL so that a screen of the utilization URL is outputted in the web browser, or a step of creating a layer at the output position of the utilization-section on the outputted webpage of the target website and injecting the utilization URL into the layer so that the utilization URL may be called.

According to another aspect of the present invention, in a website-section assembling system including a utilization website of which a section of a webpage is desired to be utilized by a user, a target website on an output display of a webpage of which the section of the webpage of the utilization website is desired to be outputted as it is assembled, a user computer having a web browser and a website-section assembling apparatus, and a website-section assembling server, there is provided a method for assembling the section of the webpage of the utilization website on the output display of the webpage of the target website comprising: a utilization-section information transmission step wherein the website-section assembling apparatus or the web browser installed in the user computer reads inputted utilization URL that is the URL of the webpage of the utilization website and position value of a utilization-section of the webpage of the utilization website and transmits the utilization URL and the position value to the website-section assembling server; a utilization-section information store step wherein the website-section assembling server receives the utilization-section information and stores it; a utilization-section information request step wherein the user computer connects to the target website and the website-section assembling apparatus in the user computer requests the utilization-section information from the website-section assembling server; and a utilization-section output step wherein the website-section assembling apparatus reads the utilization-section information and outputs the utilization-section of the webpage of the utilization website on the output display of the webpage of the target website if the website-section assembling server transmits the utilization-section information to the user computer according to the utilization-section information request.

According to the invention, it is preferable that in the utilization-section information transmission step, an input window is outputted on the user computer when the user computer connects to the website-section assembling server, and if the utilization-section information is inputted into the input window, the website-section assembling apparatus reads the inputted utilization-section information and transmits it to the website-section assembling server.

In this case, it is preferable that if the position value of the utilization-section is not inputted in the utilization-section information transmission step, the entire webpage of the utilization website is determined and stored as the utilization-section in the utilization-section information store step.

According to still another aspect of the present invention, in a website-section assembling system including a utilization website of which a section of a webpage is desired to be utilized by a user, a target website on an output display of a webpage of which the section of the webpage of the utilization website is desired to be outputted as it is assembled, a user computer having a web browser and a website-section assembling apparatus, and a website-section assembling server, there is provided a method for assembling the section of the webpage of the utilization website on the output display of the webpage of the target website comprising: a utilization-section information store step wherein if a utilization-section that is the section of the webpage of the utilization website desired to be utilized is established by means of an input device on the display of the webpage of the utilization website outputted when the user computer connects to the utilization website, and the website-section assembling apparatus or the web browser reads utilization URL that is the URL of the webpage of the utilization website and position value of the established utilization-section and transmits the utilization URL and the position value to the website-section assembling server, the website-section assembling server receives the utilization URL and the position value and stores them; a utilization-section information transmission step wherein if the user computer connects to the target website and requests the utilization-section information, the website-section assembling server transmits the utilization-section information to the user computer, and accordingly, the website-section assembling apparatus receiving the utilization-section information reads the utilization-section information and outputs the utilization-section of the webpage of the utilization website on the output display of the webpage of the target website.

According to still another aspect of the present invention, in a website-section assembling system including a utilization website of which a section of a webpage is desired to be utilized by a user, a target website on an output display of a webpage of which the section of the webpage of the utilization website is desired to be outputted as it is assembled, a user computer having a web browser and a website-section assembling apparatus, and a website-section assembling server, there is provided a method for assembling the section of the webpage of the utilization website on the output display of the webpage of the target website comprising: a utilization-section information transmission step wherein if a utilization-section that is the section of the webpage of the utilization website desired to be utilized is established by means of an input device on the display of the webpage of the utilization website outputted when the user computer connects to the utilization website, the website-section assembling apparatus reads utilization URL that is the URL of the webpage of the utilization website and position value of the established utilization-section and transmits the utilization URL and the position value to the website-section assembling server; and the website-section assembling server receives the utilization-section information and stores it; a utilization-section information request step wherein when the user computer connects to the target website, the website-section assembling apparatus requests the utilization-section information from the website-section assembling server; and a utilization-section output step wherein the website-section assembling apparatus reads the utilization-section information and outputs the utilization-section of the webpage of the utilization website on the output display of the webpage of the target website if the website-section assembling server transmits the utilization-section information to the user computer according to the utilization-section information request.

The present invention provides a computer-readable recording medium recording a computer program for implementing the steps described above.

According to still another aspect of the present invention, in a website-section assembling system including a utilization website of which a section of a webpage is desired to be utilized by a user, a target website on an output display of a webpage of which the section of the webpage of the utilization website is desired to be outputted as it is assembled, a user computer having a web browser and a website-section assembling apparatus, and a website-section assembling server, there is provided a method for assembling the section of the webpage of the utilization website on the output display of the webpage of the target website comprising: a utilization-section information transmission step wherein the website-section assembling apparatus reads utilization URL that is the URL of the webpage of the utilization website inputted into the user computer and position value of a utilization-section of the webpage of the utilization website and transmits the utilization URL and the position value to the website-section assembling server; and the website-section assembling server receives the utilization-section information and stores it; a utilization-section information request step wherein when the user computer connects to the target website, the website-section assembling apparatus requests the utilization-section information from the website-section assembling server; and a utilization-section output step wherein the website-section assembling apparatus reads the utilization-section information and outputs the utilization-section of the webpage of the utilization website on the output display of the webpage of the target website if the website-section assembling server transmits the utilization-section information to the user computer according to the utilization-section information request.

The present invention provides a computer-readable recording medium recording a computer program for implementing the steps described above.

According to still another aspect of the present invention, in a website-section assembling system including a utilization website of which a section of a webpage is desired to be utilized by a user, a target website on an output display of a webpage of which the section of the webpage of the utilization website is desired to be outputted as it is assembled, a user computer having a web browser and a website-section assembling apparatus, and a website-section assembling server, there is provided a method for assembling the section of the webpage of the utilization website on the output display of the webpage of the target website comprising: a utilization-section information store step wherein if the website-section assembling apparatus or the web browser installed in the user computer reads inputted utilization URL that is the URL of the webpage of the utilization website and position value of a utilization-section of the webpage of the utilization website and transmits the utilization URL and the position value to the website-section assembling server, the website-section assembling server receives the utilization URL and the position value and stores them; and a utilization-section information transmission step wherein if the user computer connects to the target website and requests the utilization-section information, the website-section assembling server transmits the utilization-section information to the user computer, and accordingly, the website-section assembling apparatus receiving the utilization-section information reads the utilization-section information and outputs the utilization-section of the webpage of the utilization website on the output display of the webpage of the target website.

According to still another aspect of the present invention, in a website-section assembling system including a utilization website of which a section of a webpage is desired to be utilized by a user, a target website on an output display of a webpage of which the section of the webpage of the utilization website is desired to be outputted as it is assembled, a user computer having a web browser and a website-section assembling apparatus, and a website-section assembling server, there is provided a method for assembling the section of the webpage of the utilization website on the output display of the webpage of the target website comprising: a utilization-section information transmission step wherein if a utilization-section that is the section of the webpage of the utilization website desired to be utilized is established by means of an input device on the display of the webpage of the utilization website outputted when the user computer connects to the utilization website, the website-section assembling apparatus or the web browser reads utilization URL that is the URL of the webpage of the utilization website and position value of the established utilization-section and transmits the utilization URL and the position value to the website-section assembling server; a utilization-section information store step wherein the website-section assembling server receives the utilization-section information and stores it; a target URL transmission step wherein the website-section assembling apparatus of the user computer reads target URL that is the URL of the webpage of the target website and transmits the target URL to the website-section assembling server; a target URL store step wherein the website-section assembling server receives the target URL and stores it in correspondence to the utilization-section information; a utilization-section information request step wherein the user computer connects to the webpage of the target website, and the website-section assembling apparatus requests the utilization-section information corresponding to the target URL from the website-section assembling server; and a utilization-section output step wherein the website-section assembling apparatus reads the utilization-section information and outputs the utilization-section of the webpage of the utilization website on the output display of the webpage of the target website if the website-section assembling server transmits the utilization-section information to the user computer according to the utilization-section information request.

According to the invention, it is preferable that the target URL transmission step is a target section information transmission step wherein if a target position that is a position where the utilization-section is desired to be outputted is set by means of an input device on the output display of the webpage of the target website outputted when the user computer connects to the target website, the website-section assembling apparatus reads the target position value and the target URL and transmits them to the website-section assembling server; the target URL store step is a target section information store step wherein the website-section assembling server receives the target section information and stores it; the utilization-section information request step is a section information request step wherein the website-section assembling apparatus requests the target position and the utilization-section information from the website-section assembling server; and the utilization-section output step is a target position output step wherein the website-section assembling apparatus outputs the utilization-section of the webpage of the utilization website at the target position on the output display of the webpage of the target website.

According to the invention, it is preferable that the utilization-section is outputted at a position corresponding to the position value previously set in the website-section assembling apparatus or the website-section assembling server or at a randomly selected position, and the outputted utilization-section can be moved by handling the input device of the user computer.

In this case, the outputted utilization-section can be moved to a position desired by the user on the output display of the target website by dragging a mouse connected to the user computer.

According to the invention, it is preferable that in the utilization-section output step, the website-section assembling apparatus creates a layer at the target position on the outputted webpage of the target website and injects the utilization URL into the layer so that the utilization URL may be called.

According to the invention, it is preferable that the layer is created to have a size of the utilization-section, and a webpage corresponding to the utilization URL is outputted on the layer created at the position of the utilization-section on the webpage of the target website.

According to the invention, it is preferable that in the utilization-section output step, the website-section assembling apparatus creates the layer having a size of the utilization-section at the output position on the webpage of the target website using a div tag and injects an iframe tag into the layer so that the utilization URL may be called, and at this point, a position of a scroll bar on a webpage corresponding to the URL called by the iframe is set to a top-left coordinate value contained in the utilization-section position value.

According to the invention, it is preferable that VISUAL among attributes of the scroll bar is set to NO so that the scroll bar may not be shown from outside.

According to the invention, it is preferable that the utilization-section output step creates a new window at the output position of the utilization-section on the output display of the webpage of the target website, outputs the web browser in the new window, and calls the utilization URL so that a screen of the utilization URL is outputted in the web browser.

According to the invention, it is preferable that in the utilization-section output step, the website-section assembling apparatus selectively performs a step of creating a new window at the output position of the utilization-section on the output display of the webpage of the target website, outputting the web browser in the new window, and calling the utilization URL so that a screen of the utilization URL is outputted in the web browser, or a step of creating a layer at the output position of the utilization-section on the outputted webpage of the target website and injecting the utilization URL inside the layer into the layer so that the utilization URL may be called.

According to still another aspect of the present invention, in a website-section assembling system including a utilization website of which a section of a webpage is desired to be utilized by a user, a target website on an output display of a webpage of which the section of the webpage of the utilization website is desired to be outputted as it is assembled, a user computer having a web browser and a website-section assembling apparatus, and a website-section assembling server, there is provided a method for assembling the section of the webpage of the utilization website on the output display of the webpage of the target website comprising: a utilization-section information transmission step wherein if a utilization-section that is the section of the webpage of the utilization website desired to be utilized is established by means of an input device on the display of the webpage of the utilization website outputted when the user computer connects to the utilization website, the website-section assembling apparatus or the web browser reads utilization URL that is the URL of the webpage of the utilization website and position value of the established utilization-section and transmits the utilization URL and the position value to the website-section assembling server; a target URL transmission step wherein the website-section assembling apparatus of the user computer reads target URL that is the URL of the webpage of the target website and transmits the target URL to the website-section assembling server; a utilization webpage creation step wherein the website-section assembling server creates a utilization webpage that is a webpage for outputting the utilization-section of the webpage of the utilization website to be fitted to a size of the utilization-section according to the received utilization-section information; a target URL store step wherein the website-section assembling server receives the target URL and stores it in correspondence to the utilization-section information or URL of the utilization webpage; a target URL connection step wherein the user computer connects to the webpage of the target website, and the website-section assembling apparatus informs the website-section assembling server of the target URL; and a utilization-section output step wherein if the website-section assembling server transmits the URL of the utilization webpage to the user computer, the website-section assembling apparatus creates a layer at an output position on the webpage of the target website and injects the URL of the utilization webpage into the layer so that the utilization webpage can be called from the layer, and the utilization-section of the webpage of the utilization website is outputted at the output position on the output display of the webpage of the target website.

According to the invention, it is preferable that the website-section assembling server transmits information on the size of the utilization-section to the user computer together with the URL of the utilization webpage, and the layer is created to the size of the utilization-section.

According to the invention, it is preferable that in the utilization webpage creation step, the website-section assembling server creates the layer at a top-left (0, 0) position in the size of the utilization-section and injects the utilization URL into the layer so that the utilization URL may be called, and a webpage called from the layer is outputted on the layer created at the position of the utilization-section on the webpage of the target website.

According to the invention, it is preferable that in the utilization webpage creation step, the website-section assembling server creates the layer having a size of the utilization-section at the top-left (0, 0) position using a div tag and injects an iframe tag into the layer so that the utilization URL may be called, and at this point, a position of a scroll bar on a webpage corresponding to the URL called by the iframe is set to a top-left coordinate value contained in the utilization-section position value.

According to the invention, it is preferable that VISUAL among attributes of the scroll bar is set to NO so that the scroll bar may not be shown from outside.

According to the invention, it is preferable that in the utilization-section output step, the website-section assembling apparatus creates the layer at the output position on the output display of a webpage corresponding to the target URL using the div tag in the size of the utilization-section and injects the URL of the utilization webpage into the layer using the iframe tag so that the utilization URL may be called.

According to the invention, the utilization webpage may be temporarily created.

According to the invention, the website-section assembling apparatus and the web browser installed in the user computer may be integrated into one piece.

According to still another aspect of the present invention, in a website-section assembling system including a utilization website of which a section of a webpage is desired to be utilized by a user, a target website on an output display of a webpage of which the section of the webpage of the utilization website is desired to be outputted as it is assembled, a user computer having a web browser and a website-section assembling apparatus, and a website-section assembling server, there is provided a method for assembling the section of the webpage of the utilization website on the output display of the webpage of the target website comprising: a utilization-section information store step wherein if a utilization-section that is the section of the webpage of the utilization website desired to be utilized is established by means of an input device on the display of the webpage of the utilization website outputted when the user computer connects to the utilization website, and the website-section assembling apparatus or the web browser reads utilization URL that is the URL of the webpage of the utilization website and position value of the established utilization-section and transmits the utilization URL and the position value to the website-section assembling server, the website-section assembling server receives the utilization URL and the position value and stores them; a target URL store step wherein if the website-section assembling apparatus of the user computer reads target URL that is the URL of the webpage of the target website where the utilization-section is outputted and transmits the target URL to the website-section assembling server, the website-section assembling server stores the target URL; and a utilization-section information transmission step wherein if the user computer connects to the webpage of the target website and the website-section assembling apparatus requests the utilization-section information corresponding to the target URL from the website-section assembling server, the website-section assembling server transmits the utilization-section information to the user computer, and accordingly, the website-section assembling apparatus of the user computer reads the transmitted utilization-section information and outputs the utilization-section of the webpage of the utilization website on the output display of the webpage of the target website.

According to still another aspect of the present invention, in a website-section assembling system including a utilization website of which a section of a webpage is desired to be utilized by a user, a target website on an output display of a webpage of which the section of the webpage of the utilization website is desired to be outputted as it is assembled, a user computer having a web browser and a website-section assembling apparatus, and a website-section assembling server, there is provided a method for assembling the section of the webpage of the utilization website on the output display of the webpage of the target website comprising: a utilization-section information transmission step wherein if a utilization-section that is the section of the webpage of the utilization website desired to be utilized is established by means of an input device on the display of the webpage of the utilization website outputted when the user computer connects to the utilization website, the website-section assembling apparatus reads utilization URL that is the URL of the webpage of the utilization website and position value of the established utilization-section and transmits the utilization URL and the position value to the website-section assembling server; and the website-section assembling server receives the utilization-section information and stores it; a target URL transmission step wherein the website-section assembling apparatus reads target URL that is the URL of the webpage of the target website where the utilization-section is outputted and transmits the target URL to the website-section assembling server; and the website-section assembling server receives the target URL and stores it in correspondence to the utilization-section information; a utilization-section information request step wherein when the user computer connects to the webpage of the target website, the website-section assembling apparatus requests the utilization-section information corresponding to the target URL from the website-section assembling server; and a utilization-section output step wherein the website-section assembling apparatus reads the utilization-section information and outputs the utilization-section of the webpage of the utilization website on the output display of the webpage of the target website if the website-section assembling server transmits the utilization-section information to the user computer according to the utilization-section information request.

The present invention provides a computer-readable recording medium recording a computer program for implementing the steps described above.

According to still another aspect of the present invention, in a website-section assembling system including a utilization website of which a section of a webpage is desired to be utilized by a user, a target website on an output display of a webpage of which the section of the webpage of the utilization website is desired to be outputted as it is assembled, a user computer having a web browser and a website-section assembling apparatus, and a website-section assembling server, there is provided a method for assembling the section of the webpage of the utilization website on the output display of the webpage of the target website comprising: a utilization-section information transmission step wherein the website-section assembling apparatus or the web browser installed in the user computer reads utilization URL that is the URL of the webpage of the utilization website inputted into the user computer and position value of a utilization-section of the webpage of the utilization website and transmits the utilization URL and the position value to the website-section assembling server; a utilization-section information store step wherein the website-section assembling server receives the utilization-section information and stores it; a target URL transmission step wherein the website-section assembling apparatus of the user computer reads target URL that is the URL of the webpage of the target website and transmits the target URL to the website-section assembling server; a target URL store step wherein the website-section assembling server receives the target URL and stores it in correspondence to the utilization-section information; a utilization-section information request step wherein the user computer connects to the webpage of the target website, and the website-section assembling apparatus requests the utilization-section information corresponding to the target URL from the website-section assembling server; and a utilization-section output step wherein the website-section assembling apparatus reads the utilization-section information and outputs the utilization-section of the webpage of the utilization website on the output display of the webpage of the target website if the website-section assembling server transmits the utilization-section information to the user computer according to the utilization-section information request.

According to the invention, it is preferable that in the utilization-section information transmission step, an input window is outputted on the user computer when the user computer connects to the website-section assembling server, and if the utilization-section information is inputted into the input window, the website-section assembling apparatus reads the inputted utilization-section information and transmits it to the website-section assembling server.

According to the invention, it is preferable that if the position value of the utilization-section is not inputted in the utilization-section information transmission step, the entire webpage of the utilization website is determined and stored as the utilization-section in the utilization-section information store step.

According to the invention, it is preferable that the utilization URL includes a source path.

According to the invention, it is preferable that the website-section assembling method further comprises: a utilization webpage creation step wherein the website-section assembling server creates a utilization webpage that is a webpage for outputting the utilization-section of the webpage of the utilization website to be fitted to a size of the utilization-section, at this point in the utilization-section output step, if the website-section assembling server transmits URL of the utilization webpage to the user computer, the website-section assembling apparatus creates a layer at an output position on the webpage of the target website and injects the URL of the utilization webpage into the layer so that the utilization webpage can be called from the layer, and the utilization-section of the webpage of the utilization website is outputted at the output position on the webpage of the target website.

According to the invention, it is preferable that the website-section assembling server transmits information on the size of the utilization-section to the user computer together with the URL of the utilization webpage, and the layer is created to the size of the utilization-section.

According to the invention, it is preferable that in the utilization webpage creation step, the website-section assembling server creates the layer at a top-left (0, 0) position in the size of the utilization-section and injects the utilization URL into the layer so that the utilization URL may be called, and a webpage called from the layer is outputted on the layer created at the position of the utilization-section on the webpage of the target website.

According to the invention, it is preferable that in the utilization webpage creation step, the website-section assembling server creates the layer having a size of the utilization-section at the top-left (0, 0) position using a div tag and injects an iframe tag into the layer so that the utilization URL may be called, and at this point, a position of a scroll bar on a webpage corresponding to the URL called by the iframe is set to a top-left coordinate value contained in the utilization-section position value.

According to the invention, it is preferable that VISUAL among attributes of the scroll bar is set to NO so that the scroll bar may not be shown from outside.

According to still another aspect of the present invention, in a website-section assembling system including a utilization website of which a section of a webpage is desired to be utilized by a user, a target website on an output display of a webpage of which the section of the webpage of the utilization website is desired to be outputted as it is assembled, a user computer having a web browser and a website-section assembling apparatus, and a website-section assembling server, there is provided a method for assembling the section of the webpage of the utilization website on the output display of the webpage of the target website comprising: a utilization-section information store step wherein if the website-section assembling apparatus or the web browser installed in the user computer reads utilization URL that is the URL of the webpage of the utilization website inputted into the user computer and position value of a utilization-section of the webpage of the utilization website and transmits the utilization URL and the position value to the website-section assembling server, the website-section assembling server receives the utilization URL and the position value and stores them; a target URL store step wherein if the website-section assembling apparatus of the user computer reads target URL that is the URL of the webpage of the target website where the utilization-section is outputted and transmits the target URL to the website-section assembling server, the website-section assembling server stores the target URL; and a utilization-section information transmission step wherein if the user computer connects to the webpage of the target website and the website-section assembling apparatus requests the utilization-section information corresponding to the target URL from the website-section assembling server, the website-section assembling server transmits the utilization-section information to the user computer, and accordingly, the website-section assembling apparatus of the user computer reads the transmitted utilization-section information and outputs the utilization-section of the webpage of the utilization website on the output display of the webpage of the target website.

According to still another aspect of the present invention, in a website-section assembling system including a utilization website of which a section of a webpage is desired to be utilized by a user, a target website on an output display of a webpage of which the section of the webpage of the utilization website is desired to be outputted as it is assembled, a user computer having a web browser and a website-section assembling apparatus, and a website-section assembling server, there is provided a method for assembling the section of the webpage of the utilization website on the output display of the webpage of the target website comprising: a utilization-section information transmission step wherein the website-section assembling apparatus reads utilization URL that is the URL of the webpage of the utilization website inputted into the user computer and position value of a utilization-section of the webpage of the utilization website and transmits the utilization URL and the position value to the website-section assembling server; and the website-section assembling server receives the utilization-section information and stores it; a target URL transmission step wherein the website-section assembling apparatus reads target URL that is the URL of the webpage of the target website where the utilization-section is outputted and transmits the target URL to the website-section assembling server; and the website-section assembling server receives the target URL and stores it in correspondence to the utilization-section information; a utilization-section information request step wherein when the user computer connects to the webpage of the target website, the website-section assembling apparatus requests the utilization-section information corresponding to the target URL from the website-section assembling server; and a utilization-section output step wherein the website-section assembling apparatus reads the utilization-section information and outputs the utilization-section of the webpage of the utilization website on the output display of the webpage of the target website if the website-section assembling server transmits the utilization-section information to the user computer according to the utilization-section information request.

The present invention provides a computer-readable recording medium recording a computer program for implementing the steps described above.

According to still another aspect of the present invention, in a website-section assembling system including a target website on an output display of a webpage of which a specific screen is desired to be outputted as it is assembled, a user computer having a web browser and a website-section assembling apparatus, and a website-section assembling server, there is provided a method for assembling the section of the webpage of the utilization website on the output display of the webpage of the target website comprising: a program syntax transmission step wherein the website-section assembling apparatus or the web browser installed in the user computer receives program syntax configuring the specific screen and transmits the program syntax to the website-section assembling server; a utilization webpage creation step wherein the website-section assembling server receives the program syntax and creates a utilization webpage that is a webpage for outputting the specific screen according to the program syntax; a target URL transmission step wherein the website-section assembling apparatus of the user computer reads target URL that is the URL of the webpage of the target website and transmits the target URL to the website-section assembling server; a target URL store step wherein the website-section assembling server receives the target URL and stores it in correspondence to the URL of the utilization webpage or the program syntax; a utilization webpage request step wherein the user computer connects to the webpage of the target website, and the website-section assembling apparatus requests URL of the utilization webpage corresponding to the target URL from the website-section assembling server; and a specific screen output step wherein if the website-section assembling server transmits the URL of the utilization webpage to the user computer according to the utilization webpage request step, the website-section assembling apparatus reads the URL of the utilization webpage and outputs the specific screen on the output display of the webpage of the target website.

According to the invention, the program syntax configuring the specific screen may be created in an html, an object code, or a script.

According to still another aspect of the present invention, in a website-section assembling system including a target website on an output display of a webpage of which a specific screen is desired to be outputted as it is assembled, a user computer having a web browser and a website-section assembling apparatus, and a website-section assembling server, there is a method for assembling the section of the webpage of the utilization website on the output display of the webpage of the target website comprising: a utilization webpage creation step wherein if the website-section assembling apparatus or the web browser installed in the user computer receives program syntax configuring the specific screen and transmits the program syntax to the website-section assembling server, the website-section assembling server creates a utilization webpage that is a webpage for outputting the specific screen according to the program syntax; a target URL store step wherein if the website-section assembling apparatus of the user computer reads target URL that is the URL of the webpage of the target website and transmits the target URL, the website-section assembling server stores the target URL in correspondence to the URL of the utilization webpage or the program syntax; and a utilization webpage URL transmission step wherein if the user computer connects to the webpage of the target website and the website-section assembling apparatus requests URL of the utilization webpage corresponding to the target URL from the website-section assembling server, the website-section assembling server transmits the URL of the utilization webpage to the user computer, and the website-section assembling apparatus reads the URL of the utilization webpage and outputs the specific screen on the output display of the webpage of the target website.

According to still another aspect of the present invention, in a website-section assembling system including a target website on an output display of a webpage of which a specific screen is desired to be outputted as it is assembled, a user computer having a web browser and a website-section assembling apparatus, and a website-section assembling server, there is provided a method for assembling the section of the webpage of the utilization website on the output display of the webpage of the target website comprising: a screen configuration program syntax transmission step wherein the website-section assembling apparatus reads program syntax for configuring the specific screen inputted into the user computer and transmits the program syntax to the website-section assembling server; and the website-section assembling server receives the program syntax and creates a utilization webpage that is a webpage for outputting the specific screen according to the program syntax; a target URL transmission step wherein the website-section assembling apparatus reads target URL that is the URL of the webpage of the target website and transmits the target URL to the website-section assembling server; and the website-section assembling server receives the target URL and stores it in correspondence to URL of the utilization webpage or the program syntax; a utilization webpage request step wherein the user computer connects to the webpage of the target website, and the website-section assembling apparatus requests URL of the utilization webpage corresponding to the target URL from the website-section assembling server; and a specific screen output step wherein if the website-section assembling server transmits the URL of the utilization webpage to the user computer according to the utilization webpage request step, the website-section assembling apparatus reads the URL of the utilization webpage and outputs the specific screen on the output display of the webpage of the target website.

The present invention provides a computer-readable recording medium recording a computer program for implementing the steps described above.

According to still another aspect of the present invention, in a website-section assembling system including a utilization website of which a section of a webpage is desired to be utilized by a user, a target website on an output display of a webpage of which the section of the webpage of the utilization website is desired to be outputted as it is assembled, a user computer having a web browser and a website-section assembling apparatus, and a website-section assembling server, there is provided a method for assembling the section of the webpage of the utilization website on the output display of the webpage of the target website comprising: a utilization-section information transmission step wherein if a utilization-section that is the section of the webpage of the utilization website desired to be utilized is established by means of an input device on the display of the webpage of the utilization website outputted when the user computer connects to the utilization website, the website-section assembling apparatus reads utilization URL that is the URL of the webpage of the utilization website and position value of the established utilization-section and transmits the utilization URL and the position value to the website-section assembling server; a target URL transmission step wherein the website-section assembling apparatus reads target URL that is the URL of the webpage of the target website and transmits the target URL to the website-section assembling server; and the website-section assembling server creates a utilization webpage that is a webpage for outputting the utilization-section of the webpage of the utilization website to be fitted to a size of the utilization-section according to the received utilization-section information; and the website-section assembling server receives the target URL and stores it in correspondence to the utilization-section information or URL of the utilization webpage; a target URL connection step wherein when the user computer connects to the webpage of the target website, the website-section assembling apparatus informs the website-section assembling server of the target URL; and a utilization-section output step wherein if the website-section assembling server transmits the URL of the utilization webpage to the user computer, the website-section assembling apparatus creates a layer at an output position on the webpage of the target website and injects the URL of the utilization webpage into the layer so that the utilization webpage can be called from the layer, and the utilization-section of the webpage of the utilization website is outputted at the output position on the output display of the webpage of the target website.

The present invention provides a computer-readable recording medium recording a computer program for implementing the steps described above.

According to still another aspect of the present invention, there is provided a method of creating a website-section assembling file performed on a utilization website of which a section of a webpage is desired to be utilized by a user and a target website on an output display of a webpage of which the section of the webpage of the utilization website is desired to be outputted as it is assembled, by a website-section assembling file creation apparatus installed in a user computer, the method comprising the steps of: if a utilization-section that is the section of the webpage of the utilization website desired to be utilized is established by means of an input device on the display of the webpage of the utilization website outputted when the user computer connects to the utilization website, reading utilization URL that is the URL of the webpage of the utilization website and position value of the established utilization-section; reading target URL that is the URL of the webpage of the target website at which the section of the webpage of the utilization website is desired to be outputted as it is assembled; and creating the website-section assembling file executed to output the utilization-section of the webpage of the utilization website on the output display of the webpage of the target website corresponding to the target URL according to the utilization URL and the position value of the utilization-section, when the user computer having the web browser connects to the target URL.

According to still another aspect of the present invention, in a website-section assembling system including a utilization website of which a section of a webpage is desired to be utilized by a user, a target website on an output display of a webpage of which the section of the webpage of the utilization website is desired to be outputted as it is assembled, a user computer having a web browser and a website-section assembling apparatus, and a website-section assembling server, there is provided a method for assembling the section of the webpage of the utilization website on the output display of the webpage of the target website comprising the steps of: a utilization-section that is the section of the webpage of the utilization website desired to be utilized is established by means of an input device on the display of the webpage of the utilization website outputted when the user computer connects to the utilization website, reading utilization URL that is the URL of the webpage of the utilization website and position value of the established utilization-section and transmitting the utilization URL and the position value to the website-section assembling server by the website-section assembling apparatus or the web browser; and if the website-section assembling apparatus of the user computer reads target URL that is the URL of the webpage of the target website and transmits the target URL to the website-section assembling server, creating a website-section assembling file executed to output the utilization-section of the webpage of the utilization website on the output display of the webpage of the target website according to the utilization URL and the position value of the established utilization-section when the user computer having the web browser connects to the target URL.

According to still another aspect of the present invention, in a website-section assembling system including a utilization website of which a section of a webpage is desired to be utilized by a user, a target website on an output display of a webpage of which the section of the webpage of the utilization website is desired to be outputted as it is assembled, a user computer having a web browser and a website-section assembling apparatus, and a website-section assembling server, there is provided a method for assembling the section of the webpage of the utilization website on the output display of the webpage of the target website comprising the steps of: if a utilization-section that is the section of the webpage of the utilization website desired to be utilized is established by means of an input device on the display of the webpage of the utilization website outputted when the user computer connects to the utilization website, reading utilization URL that is the URL of the webpage of the utilization website and position value of the established utilization-section and transmitting the utilization URL and the position value to the website-section assembling server by the website-section assembling apparatus or the web browser; and if the website-section assembling apparatus of the user computer reads target URL that is the URL of the webpage of the target website and transmits the target URL to the website-section assembling server, creating a utilization webpage that is a webpage for outputting the utilization-section of the webpage of the utilization website to be fitted to a size of the utilization-section according to the received utilization-section information by the website-section assembling server; and creating a website-section assembling file executed to output the utilization-section of the webpage of the utilization website on the output display of the webpage of the target website according to URL of the utilization webpage when the user computer having the web browser connects to the target URL.

According to still another aspect of the present invention, in a website-section assembling system including a utilization website of which a section of a webpage is desired to be utilized by a user, a user computer having a web browser and a website-section assembling apparatus, and a website-section assembling server, there is provided a method for assembling the section of the webpage of the utilization website on an output display of a webpage of a target website comprising the steps of: if a utilization-section that is the section of the webpage of the utilization website desired to be utilized is established by means of an input device on the display of the webpage of the utilization website outputted when the user computer connects to the utilization website, and if the website-section assembling apparatus or the web browser reads utilization URL that is the URL of the webpage of the utilization website and position value of the established utilization-section and transmits the utilization URL and the position value to the website-section assembling server, storing the utilization URL and the position value of the established utilization-section; creating a utilization-section output file executed to output the utilization-section of the webpage of the utilization website on an output display of a webpage to which the user computer having the web browser is connected, according to the utilization URL and the position value of the established utilization-section; and combining target URL that is the URL of a webpage of a website for outputting the utilization-section with a utilization-section output file if the target URL is inputted, and thus creating a website-section assembling file executed to output the utilization-section of the webpage of the utilization website on the output display of the webpage of the target website according to the utilization URL and the position value of the established utilization-section when the user computer having the web browser connects to the target URL.

According to still another aspect of the present invention, in a website-section assembling system including a utilization website of which a section of a webpage is desired to be utilized by a user, a user computer having a web browser and a website-section assembling apparatus, and a website-section assembling server, there is provided a method for assembling the section of the webpage of the utilization website on an output display of a webpage of a target website comprising the steps of: if a utilization-section that is the section of the webpage of the utilization website desired to be utilized is established by means of an input device on the display of the webpage of the utilization website outputted when the user computer connects to the utilization website, and if the website-section assembling apparatus or the web browser reads utilization URL that is the URL of the webpage of the utilization website and position value of the established utilization-section and transmits the utilization URL and the position value to the website-section assembling server, storing the utilization URL and the position value of the established utilization-section; creating a utilization webpage that is a webpage for outputting the utilization-section of the webpage of the utilization website to be fitted to a size of the utilization-section according to utilization-section information; creating a utilization-section output file executed to output the utilization-section of the webpage of the utilization website on the output display of the webpage of the target website according to URL of the utilization webpage when the user computer having the web browser connects to target URL; and combining target URL that is the URL of a webpage of a website for outputting the utilization-section with a utilization-section output file if the target URL is inputted, and thus creating a website-section assembling file executed to output the utilization-section of the webpage of the utilization website on the output display of the webpage of the target website when the user computer having the web browser connects to the target URL.

In the present invention, a section established as a utilization-section of a webpage of a utilization website is displayed on a webpage of a target website so that the utilization-section of the utilization website operates as if it is a part of the target website, and these settings can be stored and used whenever a user visits the target website. In addition, contents of a corresponding website can be updated in real-time as if the contents are a part of the target website by only using URL and a coordinate value without recording information on the contents of the utilization website in a database (DB). In addition, the user may handle web contents in a WYSIWYG method without specific knowledge on webpage editing.

### BRIEF DESCRIPTION OF THE DRAWINGS

FIG. 1 is a view showing the configuration of a website-section assembling system according to the present invention.

FIG. 2 is a view showing the operation sequence of a website-section assembling method according to a first embodiment of the present invention.

FIGS. 3a and 3b are views showing examples of output screens displayed in the operation sequence of a website-section assembling method according to a first embodiment of the present invention.

FIG. 4 is a view showing the operation sequence of a website-section assembling method according to a second embodiment of the present invention.

FIGS. 5a and 5b are views showing examples of output screens displayed in the operation sequence of a website-section assembling method according to a second embodiment of the present invention.

FIG. 6 is a view showing the operation sequence of a website-section assembling method according to a third embodiment of the present invention.

FIGS. 7 to 9 are views showing embodiments of creating a website-section assembling file.

### DETAILED DESCRIPTION OF THE INVENTION

The preferred embodiments of the present invention will be hereafter described in detail, with reference to the accompanying drawings.

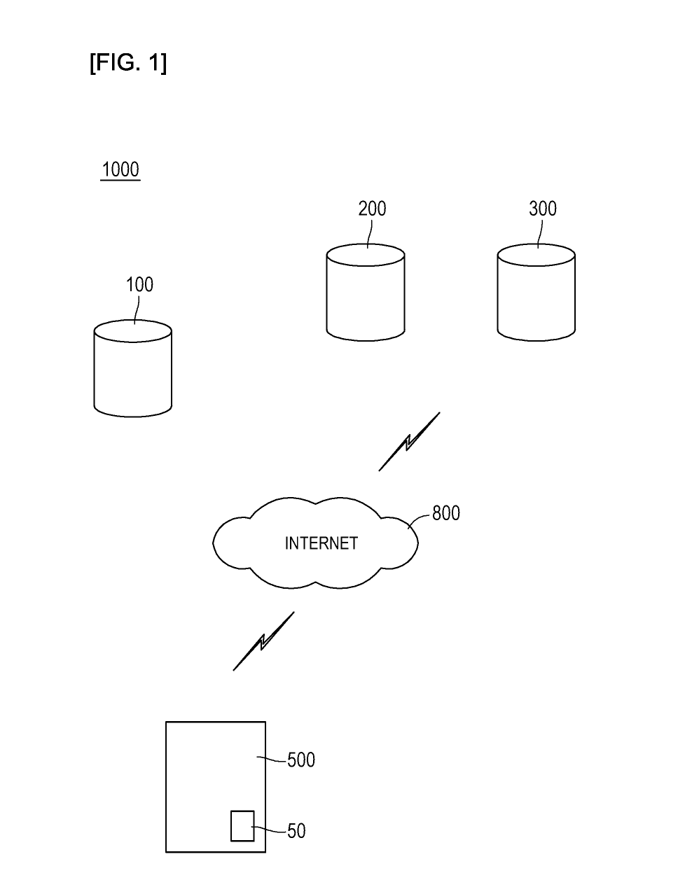

First, FIG. 1 shows a website-section assembling system 1000 according to the present invention.

According to the present invention, there is provided a website-section assembling server 100, and a website-section assembling apparatus 50 is installed in a user computer 500 having a web browser.

The user computer 500 and the website-section assembling server 100 are connected through the Internet 800.

The user computer 500 may connect to the website-section assembling server 100 through the Internet 800 and download and install the website-section assembling apparatus 50 therein, or the website-section assembling apparatus 50 can be stored in a storage device such as a CD or a USB memory and installed in the user computer 500.

A plurality of websites is connected to the Internet 800, and the websites includes a utilization website 200 and a target website 300.

The utilization website 200 is a website that a user desires to use a section of a webpage therein. The target website 300 is a website on an output display of a webpage of which the user desires to output the section of the webpage of the utilization website as it is assembled. That is, the section of the webpage of the utilization website 200 is outputted on the output display of the webpage of the target website 300.

The user computer 500 is not limited to a personal computer and includes communication terminals, such as a cellular phone or a personal digital assistant (PDA), which can be connected with the website-section assembling server 100 through the Internet 800 and transmit and receive information. In addition, the user computer includes all kinds of devices that can be connected to the website-section assembling server through the Internet, such as an Internet Protocol Television (IPTV).

According to the present invention, the website-section assembling server 100 has a close relation with the website-section assembling apparatus 50 installed in the user computer 500, and the section of the webpage of the utilization website 200 is outputted on the output display of the webpage of the target website 300 as it is assembled thereinto.

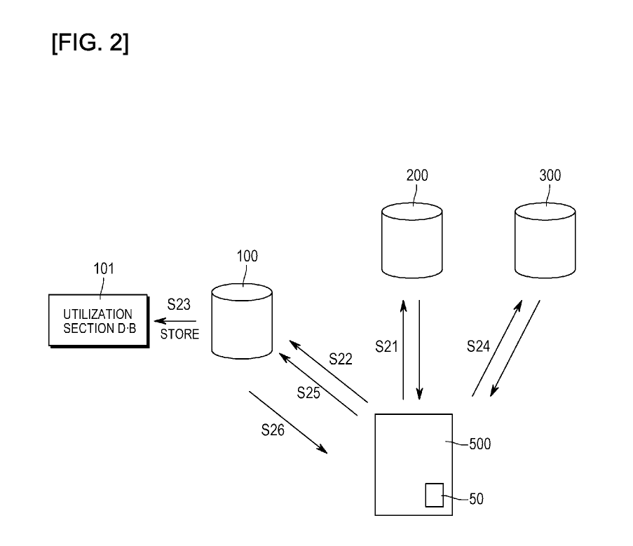

FIG. 2 is a view showing the operation sequence of a website-section assembling system 1000 according to a first embodiment of the present invention.

First, the user computer 500 connects to the utilization website 200 through the Internet 800, and accordingly, a webpage of the utilization website 200 is outputted on the monitor of the user computer 500 (Step S21).

The user computer 500 establishes a utilization-section on the output display of the webpage of the utilization website 200 by means of an input means, and the website-section assembling apparatus 50 installed in the user computer 500 reads URL of the webpage of the utilization website (hereinafter, referred to as utilization URL) having the utilization-section and position value of the established utilization-section and transmits the utilization URL and the position value to the website-section assembling server 100 (Step S22).

For example, a utilization-section is established on the display of the webpage of the utilization website 200 outputted on the monitor of the user computer by means of an input device such as a mouse, a trackball, a touchpad, a light pen, a tablet or the like.

Then, the website-section assembling apparatus 50 reads the position value of the established utilization-section. For example, when the utilization-section is established in a shape of a rectangle, X and Y values of the top-left and values of the width Wand height H can be read.

In addition, the website-section assembling apparatus 50 reads the utilization URL and transmits the utilization URL and the position value of the utilization-section to the website-section assembling server 100.

In this case, it is preferable to input and transmit user identification (ID) or the like together with the utilization URL and the position value in order to identify an individual user.

The website-section assembling server 100 receiving the utilization URL and the position value of the utilization-section from the user computer 500 stores the utilization URL and the position value in a utilization-section database 101 (Step S23).

The utilization-section database 101 basically stores the utilization URL and the position value of the utilization-section and the utilization-section database 101 may receive information, such as the user ID, a resolution, a screen shot of a corresponding section and the like, and store the information.

Next, the user computer 500 connects to the target website 300 through the Internet 800, and the webpage of the target website 300 is outputted on the user computer 500 (Step S24).

A position (a target position) at which the utilization-section of the utilization website 200 is outputted is established on the output display of the webpage of the target website 300 in the user computer 500 by means of the input device, and the website-section assembling apparatus 50 installed in the user computer 500 reads the value of the target position and requests information on the utilization-section to the website-section assembling server 100. That is, the website-section assembling apparatus 50 requests the utilization URL and the position value of the utilization-section stored in the utilization-section database 101 (Step S25).

According to the request, the website-section assembling server 100 transmits the utilization URL and the position value of the utilization-section stored in the utilization-section database 101 to the user computer 500.

Then, the website-section assembling apparatus 50 reads the utilization URL and the position value and outputs the utilization-section at the target position on the outputted webpage of the target website 300 (Step S26).

According to a preferred embodiment of the invention, the output of the utilization-section is made in a way that the website-section assembling apparatus 50 analyzes the DOM structure of the webpage of the target website and injects a code (html, CSS, script or the like) necessary to display the utilization-section.

The website-section assembling apparatus 50 creates a layer having a size of the utilization-section at the target position on the outputted webpage of the target website and injects the utilization URL into the layer so that the utilization URL is called, and output of the webpage according to the utilization URL at the layer is adjusted to the position of the utilization-section. Accordingly, the utilization-section is outputted at the target position on the outputted webpage of the target website 300.

For example, the website-section assembling apparatus 50 reads the utilization URL and the position values X, Y, W and H of the utilization-section transmitted from the website-section assembling server 100 and creates a layer having a dimension of W and H at the target position on the webpage of the target website by using a layer tag such as a div tag.

Next, a tag such as iframe is injected into the layer to call the utilization URL. At this time, the position of the outputted webpage is adjusted to the position of the utilization-section. For example, the position of a scroll bar is set to X and Y of the top-left of the position value of the utilization-section in the URL called in the iframe. In this case, VISUAL attribute of the scroll bar is set to NO so that the scroll bar is not shown.

According to the present invention, there may be a plurality of utilization websites 200 as the user selects them, and each utilization website 200 may have a plurality of utilization-sections. In addition, there may be a plurality of target websites 300.

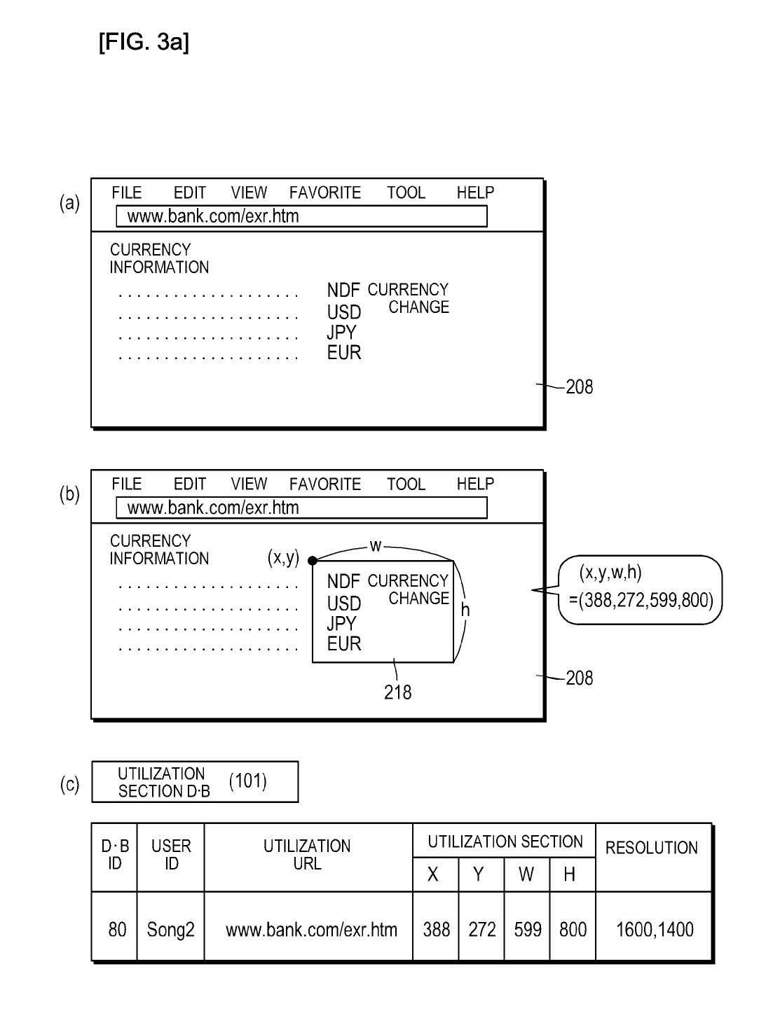

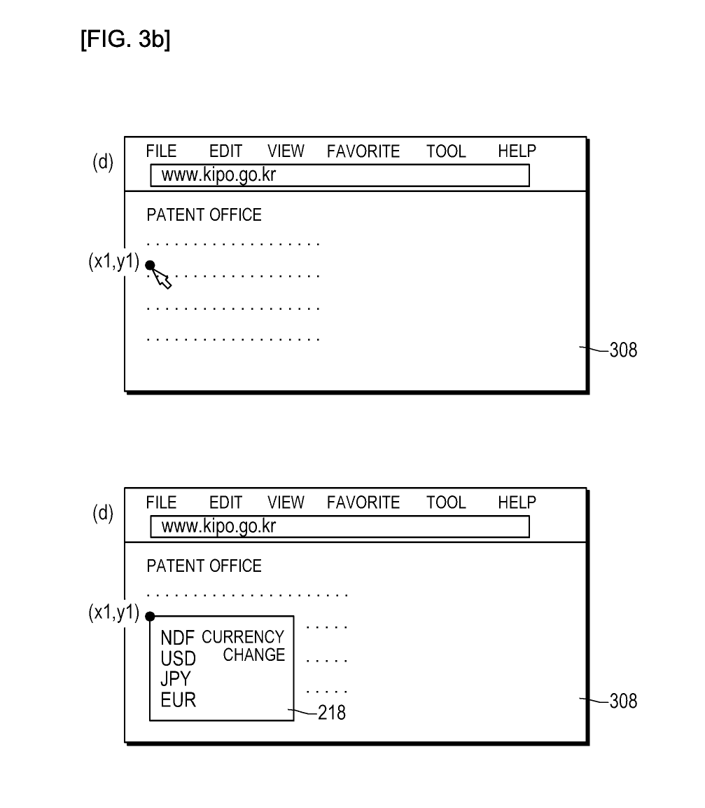

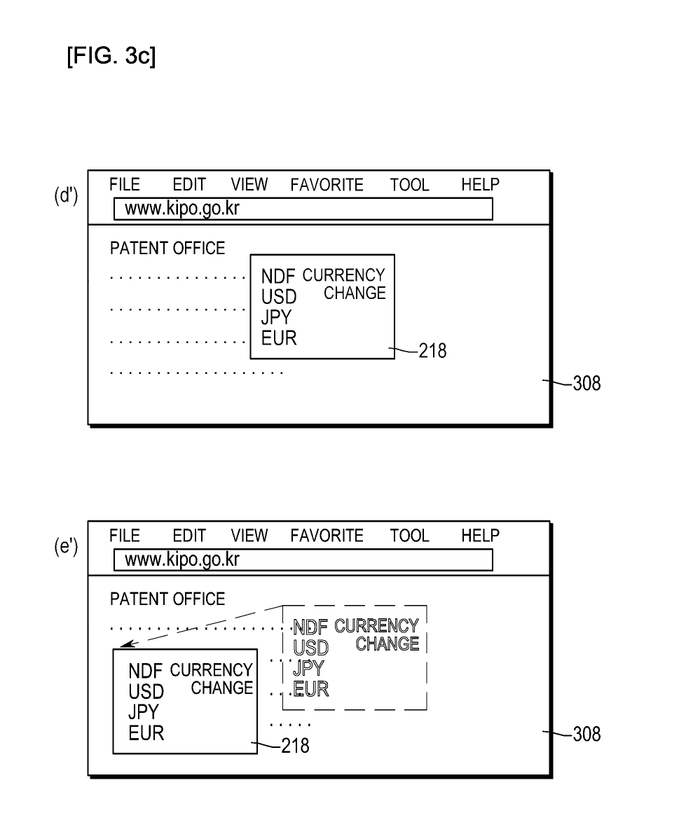

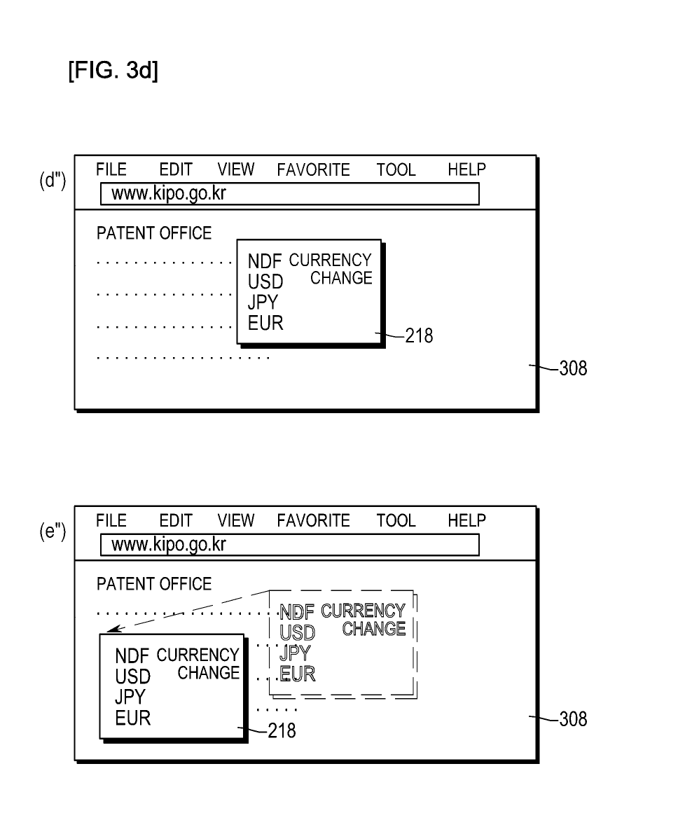

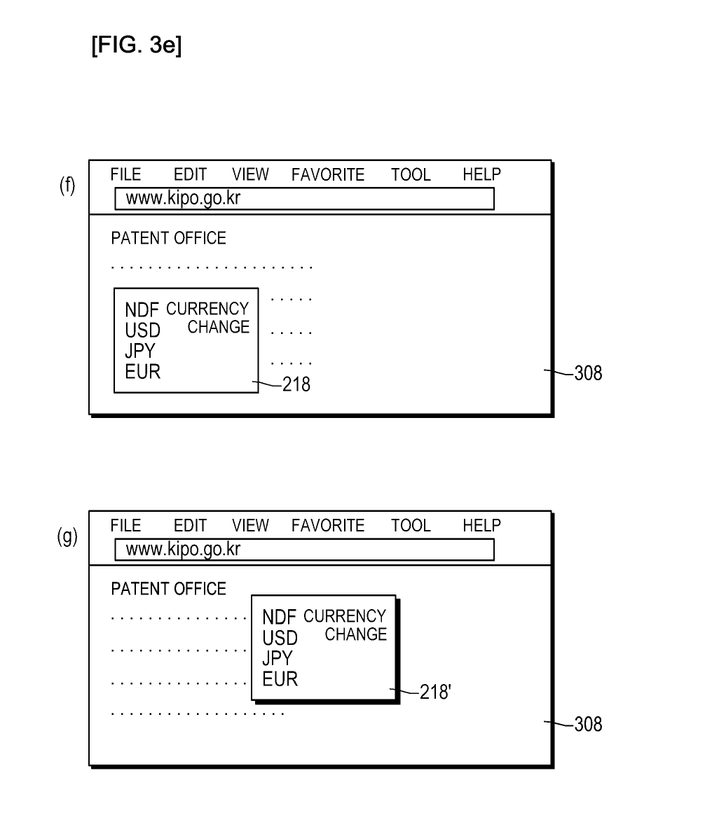

FIG. 3 is a view showing examples of website displays outputted on the user computer 500 and related databases according to a first embodiment of the present invention.

First, FIG. 3a (a) shows a display of a webpage 208 of a utilization website to which the user computer 500 is connected, and its URL is www.bank.com/exr.htm.

If a utilization-section 218 is established on the display of the webpage 208 from the user computer 500 as shown in FIG. 3a (b), the website-section assembling apparatus 50 reads position value of the utilization-section and transmits utilization-section information including the utilization URL and the position value of the utilization-section to the website-section assembling server 100.

In the display of the webpage 208, position values X, Y, W and H of the utilization-section 218 are 388, 272, 599 and 800, respectively.

The website-section assembling server 100 stores the transmitted utilization URL and position value of the utilization-section in the utilization-section database 101. FIG. 3a (c) shows an example of a database table of the utilization-section database 101.

Next, the user computer 500 connects to the target website 300, and FIG. 3b (d) shows a display of the webpage 308 of the target website. A target position (x₁, y₁) for outputting the utilization-section of the webpage of the utilization website 200 is set on the output display 308 of the target website.

The website-section assembling apparatus 50 requests the utilization URL and the position value of the utilization-section stored in the utilization-section database 101 from the website-section assembling server 100 and creates a layer having a size (W, H) of the utilization-section by using a layer tag such as a div tag at the target position (x₁, y₁) on the output display of the webpage of the target website. In addition, the website-section assembling apparatus 50 injects a tag such as iframe into the layer to call the utilization URL. At this point, the position of the outputted webpage is adjusted to the utilization-section position. That is, the position of the scroll bar is set to the utilization-section position (X, Y) in the webpage of the utilization website which is called and outputted, and the scroll bar is set not to be shown.

Accordingly, as shown in FIG. 3b (e), the utilization-section 218 of the webpage of the utilization website 200 is outputted at the target position (x₁, y₁) on the output display 308 of the target website.

According to the present invention, although the website-section assembling apparatus 50 can be independently installed in the user computer 500, it also can be integrated with a web browse as one.

According to the present invention, the utilization-section 218 does not necessarily need to be outputted at the predetermined target position by the user on the output display 308 of the webpage of the target website 300. That is, the utilization-section can be outputted at a position predetermined in the website-section assembling apparatus 50 or the website-section assembling server 100. Alternatively, utilization-section can be outputted at a random position.

In this case, it is desirable if the utilization-section 218 outputted on the output display 308 of the webpage of the target website 300 is moved to a position desired by the user by handling the input device. For example, the outputted utilization-section 218 can be moved to a position desired by the user on the output display 308 of the target website by dragging a mouse connected to the user computer 500.

FIG. 3c shows an example of this case. That is, FIG. 3c (d′) shows the utilization-section 218 outputted at the center of the output display 308 of the webpage of the target website. The center is predetermined in the website-section assembling server 100 or the website-section assembling apparatus 50. FIG. 3c (e′) shows the utilization-section 218 moved to a desired position by dragging a mouse.

According to the present invention, the output of the utilization-section 218 on the output display 308 of the webpage of the target website 300 is achieved by injecting a code necessary to output the utilization-section on the webpage of the target website as described above. In other case, it is possible by outputting a new window in which the utilization-section is outputted.

In this case, the new window is created at the output position of the utilization-section on the output display 308 of the webpage of the target website 300, and it is made that a browser is outputted in the new window. At this time, the utilization URL is called in the browser to output a display according to the URL.

FIG. 3d (d″) shows an example of the utilization-section outputted in this way. In this case, the utilization-section is outputted at the center position that is predetermined Then, the utilization-section can be moved to a desired position by dragging a mouse as shown in FIG. 3d (e″).

If the new window is outputted as described, although the webpage 308 of the target website is changed (for example, switched to www.kipo.go.kr/move.html), the utilization-section 218 still remains on the changed webpage.

According to the present invention, the output of the utilization section of the webpage of the utilization website on the output display of the webpage of the target website is selectively used from the way inserting the utilization-section into the outputted webpage of the target website or the way outputting a new window. FIG. 3e shows this case.

First, FIG. 3e (f) shows that the utilization-section 218 is outputted by injecting the code so as to output the utilization-section on the outputted webpage of the target website. In this state, it is made that the utilization-section 218 is closed, and a new window 218′ is outputted (FIG. 3e (g)).

In this case, the switch of the utilization-section gives a feeling of taking off. This can be inverted, which gives a feeling of landing.

According to the present invention, the establishment of the utilization section can be accomplished in a way that the website section assembling apparatus reads the utilization URL inputted to the user computer 500 and the position value of the utilization-section and transmits the website section assembling server.

In this case, if the user computer 500 connects to the website-section assembling server 100, an input window is outputted in the user computer, and if information on the utilization-section including the utilization URL and the utilization-section position value is inputted into the input window, the website-section assembling apparatus 50 or the web browser reads the inputted utilization-section information and transmits it to the website-section assembling server 100. Then, the website-section assembling server 100 stores the utilization-section information in the utilization-section database 101.

According to the present invention, if the position value of the utilization-section is not inputted into the input window, the entire webpage of the utilization website can be determined as a utilization-section and stored in the utilization-section database 101.

According to the present invention as described above, the section established as the utilization-section in the webpage of the utilization website 200 is outputted on the webpage of the target website 300, and the utilization-section of the utilization website operates as if it is a part of the target website. In this case, the utilization-section may be outputted at a target position set by the user on the output display of the webpage of the target website, or at a predetermined position, or at a random position. In this case, the outputted display can be moved to locate in a desired position.

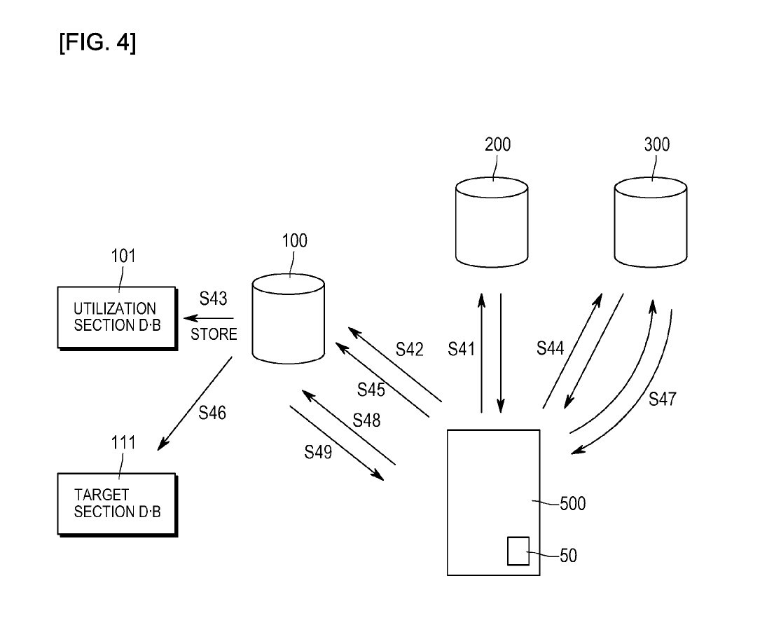

FIG. 4 is a view showing the operation sequence of a website-section assembling system 1000 according to a second embodiment of the present invention.

First, the user computer 500 connects to the utilization website 200 through the Internet 800, and accordingly, a webpage of the utilization website 200 is displayed on the user computer 500 (Step S41).

The user computer 500 establishes a section to be utilized on the outputted webpage of the utilization website 200 by means of an input means, and the website-section assembling apparatus 50 or a web browser installed in the user computer 500 reads the URL of the webpage of the utilization website, the webpage on which the utilization-section is established (the utilization URL), and position value of the established utilization-section, and transmits the utilization URL and the position value to the website-section assembling server 100 (Step S42).

The website-section assembling server 100 receiving the utilization URL and the utilization-section position value from the user computer 500 stores the utilization URL and the position value in the utilization-section database 101 (Step S43).

Next, the user computer 500 connects to the target website 300 through the Internet 800, and a webpage of the target website 300 is outputted on the user computer 500 (Step S44).

The user computer 500 establishes a target position that is a position at which the utilization-section of the utilization website 200 is outputted by means of the input means, and the website-section assembling apparatus 50 reads the value of this target position. In addition, the website-section assembling apparatus 50 reads the URL of the webpage of the target website 300 having the target position (hereinafter, referred to as a target URL) and transmits the target URL and the target position value to the website-section assembling server 100 (Step S45).

The website-section assembling server 100 receiving the target URL and the target position value stores the target URL and the position value in a target section database 111 (Step S46).

In this case, it is preferable to input and store user identification (ID) or the like together with the target URL and the target position value in order to identify an individual user.

The target section database 111 stores the target URL and the target position in relation with the utilization URL and the utilization-section position value. For example, the target URL and the target position can be stored in relation with the ID of the utilization-section database or the utilization URL directly inputted by the user, or the utilization URL and the utilization-section position value are read from the utilization-section database 101 and integratedly stored in the target section database 111 together with the target URL and the target position.

At this point, the user computer 500 outputs the target website 300 on the screen, and the website-section assembling apparatus 50 outputs the utilization-section of the utilization URL at the target position using the target section database 111.

At this point, the utilization-section can be outputted as the same way as described in the first embodiment.

Meanwhile, the website-section assembling server 100 creates a webpage (hereinafter, referred to as a utilization webpage) which outputs the utilization-section of the webpage of the utilization website by the size of the utilization-section, and the website-section assembling apparatus 50 creates a layer at the target position of the outputted webpage of the target website 300 to have the size of the utilization-section and injects into the layer so that the utilization URL is called. Accordingly, the utilization-section of the webpage of the utilization website 200 is outputted at the target position on the output display of the webpage of the target website 300.

According to an embodiment of the present invention, the website-section assembling server 100 creates the utilization webpage having a layer created at the top-left (0, 0) position by the size of the utilization-section. At this point, the utilization URL is injected into the layer so that the utilization URL is called, and the output of the webpage called in the layer is adjusted to the position of the utilization-section.

For example, the website-section assembling server 100 creates a layer having the size W and H of the utilization-section at the top-left (0, 0) position by using a layer tag such as a div tag and injects a tag such as iframe into the layer to call the utilization URL. At this time, in order to adjust the part of the webpage outputted in the layer to the position of the utilization section, in the output display of the URL called in the iframe, the position of the scroll bar is set to the utilization-section position X and Y and the scroll bar is set not to be shown.

According to the present invention, the website-section assembling server 100 can configure the utilization webpage by creating a layer having the size of W and H of the utilization-section of the utilization URL at the top-left (0, 0) position and by using an image cut of the utilization-section. The image cut may be created in a way that the website section assembling server 100 obtains the corresponding webpage through a web crawler, and then configures the page and creates the image cut. The image cut may be directly provided by the website-section assembling apparatus 50. In this case, it is preferable to provide the image cut for the service to show the utilization-section in advance. It is preferable to set a link to the utilization URL.

The website-section assembling apparatus 50 creates the layer at the target position on the output display of the webpage of the target URL by the size of the utilization-section by using a layer tag such as a div tag and injects into the layer by using a tag such as iframe so that the URL of the utilization webpage is called.

Accordingly, the utilization-section of the webpage of the utilization website 200 is outputted at the target position on the display of the webpage of the target website 300.

Such a utilization webpage can be created to be temporarily used or can be stored in the target section database 111 so as to be continuously used.

Next, if the user computer 500 connects to the target website 300 again and the webpage of the target website 300 is outputted on the user computer (Step S47), the website-section assembling apparatus 50 transmits the URL of the outputted webpage of the target website 300 (the target URL) to the website-section assembling server 100 and requests information needed to output the utilization-section (Step S48).

Then, the website-section assembling server 100 transmits the related information with reference to the target section database 111 to the website-section assembling apparatus 50 in the user computer 100, and the website-section assembling apparatus 50 outputs the utilization-section of the webpage of the utilization website at the target position on the webpage of the target website by using the information (Step S49). At this point, the output is as same as the method described above.

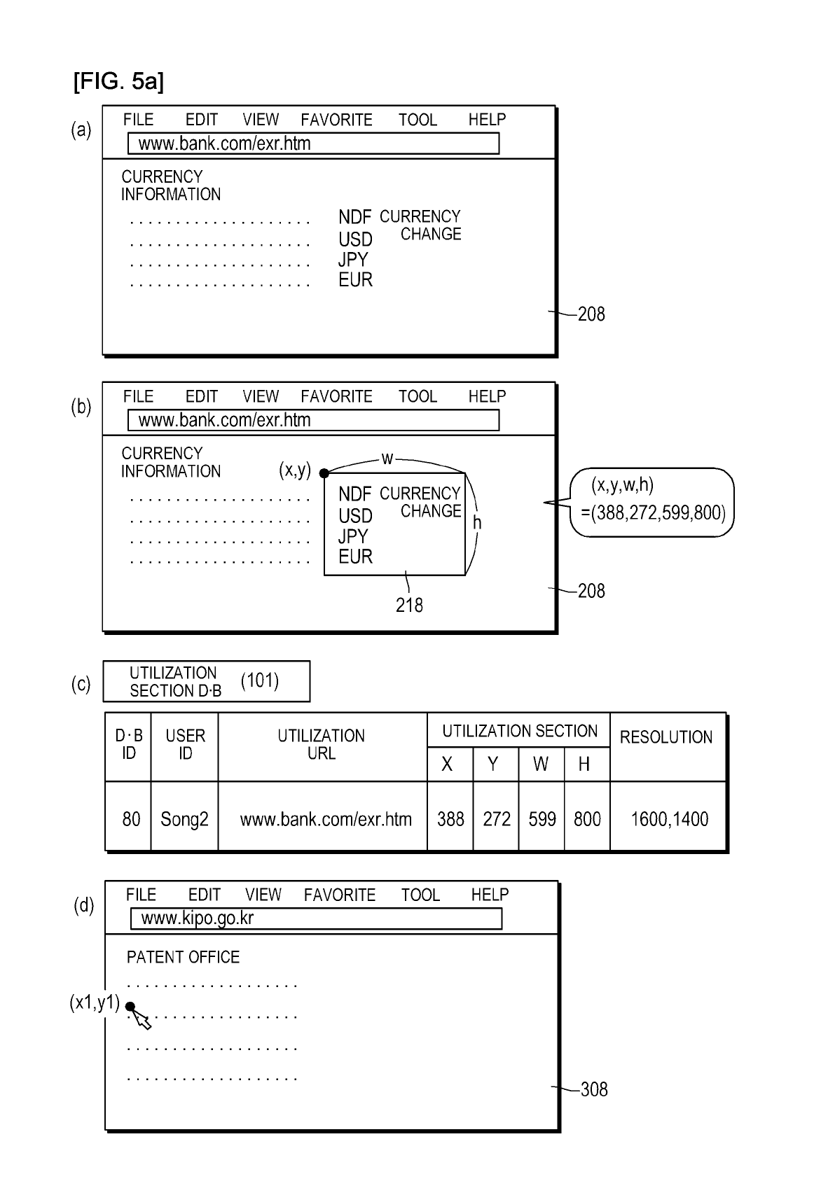

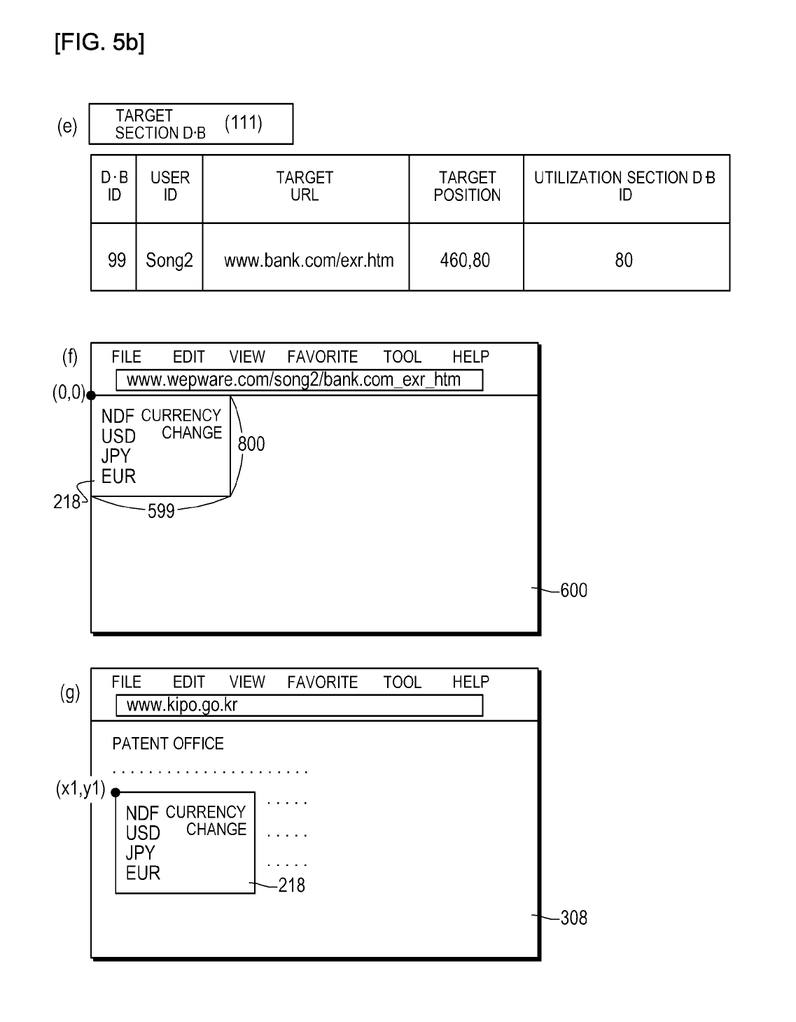

FIG. 5 is a view showing examples of website display outputted on the user computer 500 and related databases according to a second embodiment of the present invention.

First, FIG. 5 (a) shows a display of a webpage 208 of a utilization website to which the user computer 500 is connected, and its URL is www.bank.com/exr.htm.

If a utilization-section 218 is established on the display of the webpage 208 on the user computer 500 as shown in FIG. 5 (b), the website-section assembling apparatus 50 reads position value of the utilization-section and transmits the URL of the utilization target and the position value of the utilization-section to the website-section assembling server 100.

In the display of the webpage 208, position values X, Y, W and H of the utilization-section are 388, 272, 599 and 800, respectively.

The website-section assembling server 100 stores the transmitted utilization URL and position value of the utilization-section in the utilization-section database 101. FIG. 5 (c) shows an example of a database table of the utilization-section database 101.

Next, the user computer 500 connects to the target website 300, and FIG. 5 (d) shows a display of the webpage 308 of the target website. A target position (x₁, y₁) at which the utilization-section of the utilization URL is outputted is established on the output display 308 of the target website in the user computer 500.

The website-section assembling apparatus 50 reads the URL of the webpage of the target website (the target URL) and the target position and transmits them to the website-section assembling server 100, and the website-section assembling server 100 stores the target URL and the position value in the target section database 111. FIG. 5 (e) shows an example of a database table of the target section database.

In addition, a utilization webpage 600 is created as shown in FIG. 5 (f).

Then, the website-section assembling apparatus 50 outputs the utilization-section of the webpage of the utilization website 200 at the target position by using the target section database 111.

If the user computer connects to the target website 300 again, the website-section assembling apparatus 50 transmits the target URL to the website-section assembling server 100 and requests information of the utilization-section. Then, the website-section assembling server 100 refers to the utilization webpage 600 from the target section database 111. The website-section assembling server 100 transmits the target position, the size of the utilization-section and the URL of the utilization webpage to the website-section assembling apparatus 50. Accordingly, the website-section assembling apparatus 50 outputs the utilization-section of the webpage of the utilization website 200 at the target position on the output display of the webpage of the target website 300. FIG. 5 (g) shows the display outputted as such.

According to the present invention, the utilization-section 218 does not necessarily need to be outputted at a target position (x1, y1) predetermined by a user on the output display 308 of the webpage of the target website 300. That is, the utilization-section can be outputted at a position predetermined in the website-section assembling apparatus 50 or the website-section assembling server 100. Alternatively, the utilization-section can be outputted at a random position.

In this case, the utilization-section 218 outputted on the output display 308 of the webpage of the target website 300 is preferably moved to a position desired by the user by handling an input device. For example, the outputted utilization-section 218 can be moved to a position desired by the user on the output display 308 of the target website by dragging a mouse connected to the user computer 500. In relation to this, refer to FIG. 3c of the first embodiment.

According to the present invention, the output of the utilization-section 218 on the output display 308 of the webpage of the target website 300 is achieved by injecting a code necessary to output the utilization-section on the webpage of the target website as described above. In other case, it is possible by outputting a new window in which the utilization-section is outputted.

In this case, the new window is created at the output position of the utilization-section on the output display 308 of the webpage of the target website 300, and it is made that a browser is outputted in the new window. At this time, the utilization URL is called in the browser to output a display according to the URL. If the new window is outputted as described, although the webpage 308 of the target website is changed, the utilization-section 218 still remains on the changed webpage. In relation to this, refer to FIG. 3d of the first embodiment.

According to the present invention, the output of the utilization section of the webpage of the utilization website on the output display of the webpage of the target website is selectively used from the way inserting the utilization-section into the outputted webpage of the target website or the way outputting a new window. In relation to this, refer to FIG. 3e of the first embodiment.

According to the present invention, the establishment of the utilization section can be achieved in a way that the website-section assembling apparatus or the web browser reads the utilization URL and the utilization-section position value inputted into the user computer 500 and transmits the utilization URL and the position value to the website-section assembling server.

In this case, if the user computer 500 connects to the website-section assembling server 100, an input window is outputted on the user computer, and if information on the utilization-section including the utilization URL and the utilization-section position value is inputted into the input window, the website-section assembling apparatus 50 reads the inputted utilization-section information and transmits it to the website-section assembling server 100. Then, the website-section assembling server 100 stores the utilization-section information in the utilization-section database 101.

According to the present invention, if the position value of the utilization-section is not inputted into the input window, the entire webpage of the utilization website can be determined as a utilization-section and stored in the utilization-section database 101.

The utilization URL may include a source route of the utilization website. That is, the source route of the utilization website is inputted and stored. In this case, a flash or an image according to the source route is outputted on the webpage of the target website as the utilization-section. In relation to this, a ratio of the flash or the image can be adjusted.

Sample codes for outputting the utilization-section on the webpage of the target website are shown below. When outputting the utilization-section, it is preferable that an index value is adjusted in order that an added layer is not covered by another layer and is shown to the user. In addition, it is preferable to adjust the index or arrange an iframe or the like under so that the added layer is shown to the eye of the user.

Sample code 1:

<div id=“sample” style=“width:500; height:300; border:1px outset #cdcdcd;
position:absolute; top:300; left:400; z-index:900000;”>
<iframe style=“position:absolute” id=“sample_3”
src=“http://www.wepware.com/aa.htm”
width=“100%” height=“100%” marginwidth=“0”
marginheight=“0” frameborder=“0”
scrolling=“auto”></iframe>
</div>

Sample code 2:

<div id=“divTest2” style=“position:absolute; left:0px; top:0px; width:594px;
height:398px;overflow:hidden;z-index:90000; ”> (a size to be shown)
<div id=“divTest” style=“position:absolute; width:1870px; height: 1080px;overflow:auto;z-
index:900000;”> (a size of a user monitor)
<iframe id=“iframeTest” scrolling=“no” name=“iframeTest” noResize
style=“position:absolute; ” src=“http://www.sechang.com” width=“100%” height=“100%”
></iframe> (an address to be shown)
</div>
</div>
(Output a symbol “Loading” while the page is called)
<divid=“loading” style=“ position:absolute; z-index:9999999999999;
overflow:hidden;left:0;top:0; width:594px; height:398px;” >
<img id=“loading_img” style=“position:absolute; display:inline; top:200px; left:300px”
src=“/search/docservice_image_ft/WO@@@KR2011003689@@@8013481@@@http://st
g.wepware.com/app/layer/img/loading.gif” />
<iframe scrolling=“no” frameborder=“0” marginheight=“0” marginwidth=“0”
style=“position:absolute; width:2000; height:2000; z-index:-1; left:0; top:0;” ></iframe>
[187]
</div>

Meanwhile, the outputted utilization-section can be displayed as an icon smaller than the real utilization-section and shown in the original size when the user clicks the icon by using a script or CSS.

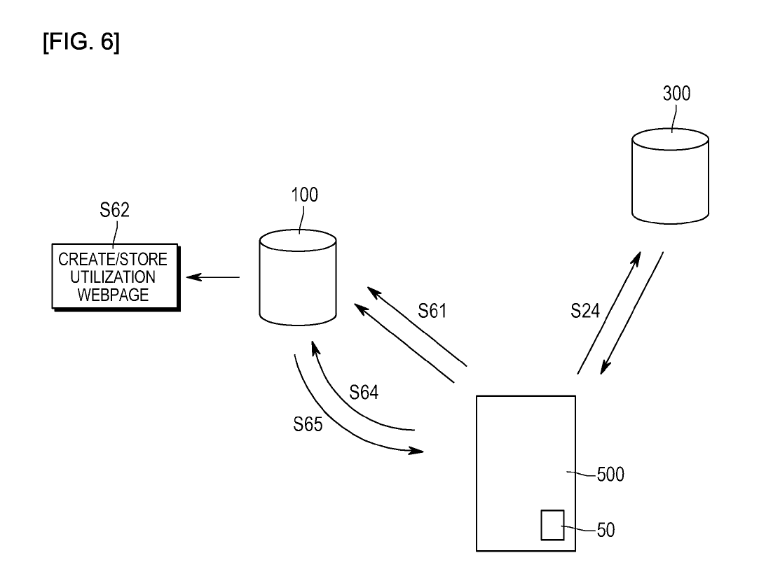

FIG. 6 is a view showing the operation sequence of a website-section assembling system 1000 according to a third embodiment of the present invention.

In this case, a user stores program sentence configuring a specific display in the website-section assembling server 100 in relation with the target URL, and the display configured according to the stored program sentence is outputted on the webpage of the target website. The program sentence can be created in html, or it can be an object code or script.

The program sentence may be a code to form the display by itself, or it can be a code to call a source stored in the other utilization websites. For example, it can be a source code of a website which provides a widget or a video. Accordingly, the user may store the source code of the widget or the video provided by various websites in the website-section assembling server 100 so that the source code can be assembled to the webpage of the target website.

First, the user computer 500 connects to the website-section assembling server 100, and the website-section assembling apparatus 50 or the web browser in the user computer 50 is inputted the program sentence configuring the specific display and transmits it to the website-section assembling server (Step S61).

For example, an input window is outputted on the user computer 500, and the program sentence is inputted into the input window and transmitted to the website-section assembling server 100.

At this point, a target URL that is the URL of the webpage of the target website can be inputted and transmitted together with the program sentence.

The target URL does not necessarily need to be transmitted together with the program sentence. For example, if a target position of a webpage desired to be outputted is set by means of an input device on a screen outputted when the user computer connects to the webpage of the target website, the website-section assembling apparatus 50 reads the target URL and the target position value and transmits them to the website-section assembling server 100.

Then, the website-section assembling server 100 receives the program sentence, creates a webpage (a utilization webpage) which outputs the display according to the program sentence, and stores the URL of the utilization webpage in relation with the target URL (Step S62).

It is preferable to store the target URL and the utilization URL in relation with personal ID and provide a customized service to each user. In this case, the transmitted program sentence can be stored together.

In another case, the target URL and the program sentence are stored in relation with the personal ID, and the utilization webpage can be temporarily created.

When the program sentence refers to a webpage of a specific utilization website, the utilization webpage can be created in the way as the first and second embodiments described above.

In addition, details of configuring the utilization webpage can be stored in a database as needed.

Next, the user computer connects to the webpage of the target website (Step S63), and the website-section assembling apparatus 50 of the user computer 500 requests the URL of the utilization webpage corresponding to the target URL to the website-section assembling server 100 (Step S64).

If the website-section assembling server 100 transmits the URL of the utilization webpage to the user computer, the website-section assembling apparatus 50 reads the URL of the utilization webpage and outputs the specific screen on the output display of the webpage of the target website.

In this case, the specific display can be outputted at the target position specified by the user, or at a predetermined specific position, or at a random position and moved to a certain position by dragging a mouse.

The details of how to create and output the utilization webpage is referred to the second embodiment case.

In the above cases, the website-section assembling apparatus 50 should be installed in the user computer 500 in order to assemble the utilization-section of the utilization website into the webpage of the target website to which the user computer 500 is connected.

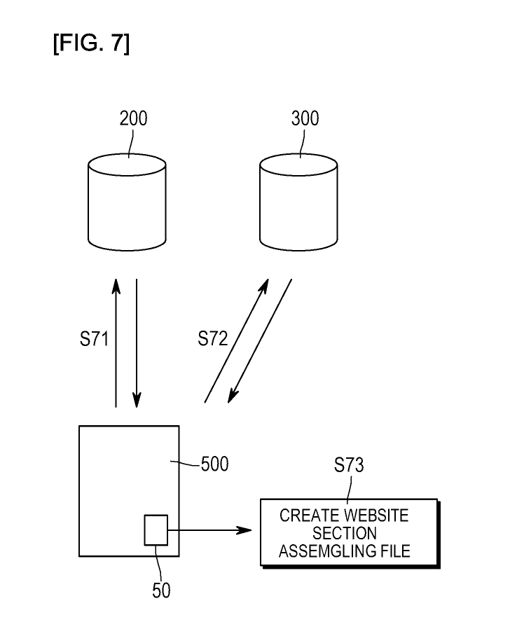

However, it does not necessarily need to install the website-section assembling apparatus in the user computer. A website-section assembling file recording program sentence for performing the operation described above is created, and if the user computer which executes the website-section assembling file connects to a specific target URL, the program sentence recorded in the website-section assembling file is executed, and the utilization-section of the utilization website can be outputted on the webpage of the target website as it is assembled thereinto. FIG. 7 shows an embodiment of this case.

First, the user computer 500 having the website-section assembling apparatus 50 connects to the utilization website 200. Accordingly, a webpage of the utilization website 200 is outputted on the monitor of the user computer 500, and the user computer 500 establishes a utilization-section on the outputted display of the webpage of the utilization website 200 by means of an input device. The website-section assembling apparatus 50 installed in the user computer 500 reads the URL of the webpage of the utilization website having the utilization-section (hereinafter, referred to as utilization URL) and position value of the established utilization-section (Step S71). In this case, the website-section assembling apparatus 50 may store the read value in a database.

Next, the user computer 500 connects to the target website 300, and a webpage of the target website 300 is outputted on the user computer 500. The website-section assembling apparatus 50 reads the URL of the webpage of the target website 300 (a target URL) (Step S72). In another case, a user may directly input the target URL through the user computer 500.

Next, the website-section assembling apparatus 50 creates a website-section assembling file (Step S73).

The website-section assembling file is the thing which is executed to output the utilization-section of the webpage of the utilization website on the output display of the webpage of the target website corresponding to the target URL according to the utilization URL and the utilization-section position value when the user computer having a web browser connects to the target URL.

For example, the website-section assembling file records the utilization URL, the utilization-section position value and the target URL, and program sentence which is executed to output the utilization-section of the webpage of the utilization website on the output display of the webpage of the target website corresponding to the target URL when the user computer having a web browser connects to the target URL.

Such program sentence can be written in a script, CSS or the like.

At this point, the program sentence may follow the same way as shown in the above embodiments to output the utilization-section of the webpage of the utilization website on the output display of the webpage of the target website corresponding to the target URL.

In addition, the utilization-section can be outputted at the target position specified by the user or at a predetermined specific position, or at a random position and moved to a certain position by dragging a mouse.

As described above, the website-section assembling apparatus 50 creates the website-section assembling file and the user computer to which the website-section assembling file is transferred or the user computer sharing the website-section assembling file can make the utilization-section of the webpage of the utilization website outputted on the output display of the webpage of the target website corresponding to the target URL by executing it although the user computer does not have the website-section assembling apparatus 50.

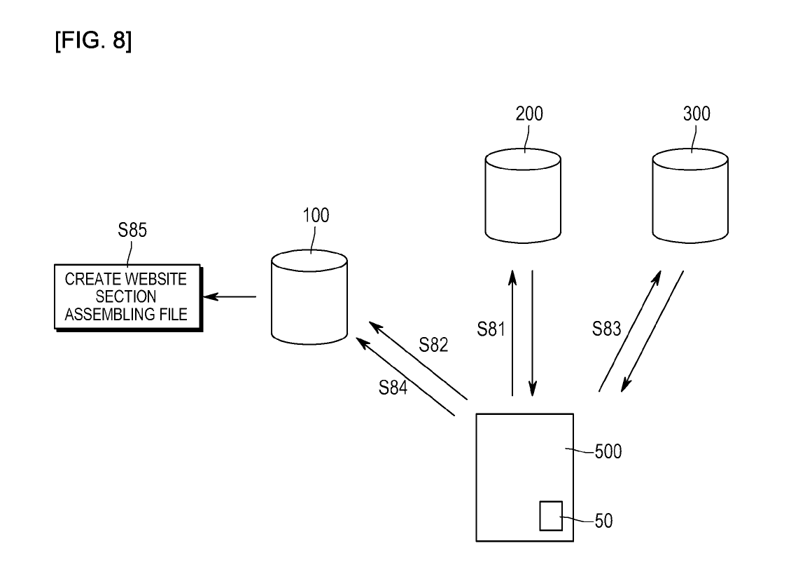

FIG. 8 is a view showing another embodiment of creating a website-section assembling file.

First, the user computer 500 connects to the utilization website 200 through the Internet 800, and accordingly, a webpage of the utilization website 200 is outputted on the user computer 500 (Step S81).

The user computer 500 establishes a section to be utilized on the outputted webpage of the utilization website 200 by means of the input means, and the website-section assembling apparatus 50 or the web browser installed in the user computer 500 reads the URL of the webpage of the utilization website on which the utilization section is established (the utilization URL) and position value of the established utilization-section and transmits the utilization URL and the position value to the website-section assembling server 100 (Step S82).

Next, the user computer 500 connects to the target website 300 through the Internet 800, and a webpage of the target website 300 is outputted on the user computer 500 (Step S83).

The website-section assembling apparatus 50 of the user computer 500 reads the URL of the webpage of the target website 300 (hereinafter, referred to as a target URL) and transmits the target URL to the website-section assembling server 100 (Step S84).

The website-section assembling server 100 receives the utilization URL, the position value of the utilization-section and the target URL and creates the website-section assembling file (Step S85).

In this case, the website-section assembling server 100 preferably stores the utilization URL and the position value of the utilization-section in a database in relation with the target URL.

The website-section assembling file is the thing which is executed to output the utilization-section of the webpage of the utilization website on the output display of the webpage of the target website according to the utilization URL and the position value of the utilization-section when the user computer having a web browser connects to the target URL.

For example, the website-section assembling file records the utilization URL, the utilization-section position value and the target URL, and program sentence which is executed to output the utilization-section of the webpage of the utilization website on the output display of the webpage of the target website corresponding to the target URL when the user computer having a web browser connects to the target URL. In other case, it can record program sentence which inquires the utilization URL, the utilization-section position value and the target URL to the website-section assembling server 100 without recording those values.

In addition, the target URL may vary, and the URL of the file to which website section assembling file is injected in the html documents can be the target URL. For example, although the website-section assembling file is created in which the URL of http://a.com/a.html is the target website, if the website-section assembling file is combined with http://b.com/b.html file, the previous utilization-section can be identically displayed in the latter URL.

Such program sentence can be written in a script, CSS or the like.

The program sentence may output the utilization-section of the webpage of the utilization website on the output display of the webpage of the target website according to the target URL in the same way as shown in the first to third embodiments.

In addition, the utilization-section can be outputted at the target position specified by the user or at a predetermined specific position, or at a random position and moved to a certain position by dragging a mouse.

As described above, the website-section assembling server 100 creates the website-section assembling file and the user computer to which the website-section assembling file is transferred or the user computer sharing the website-section assembling file can make the utilization-section of the webpage of the utilization website outputted on the output display of the webpage of the target website corresponding to the target URL by executing it although the user computer does not have the website-section assembling apparatus 50.

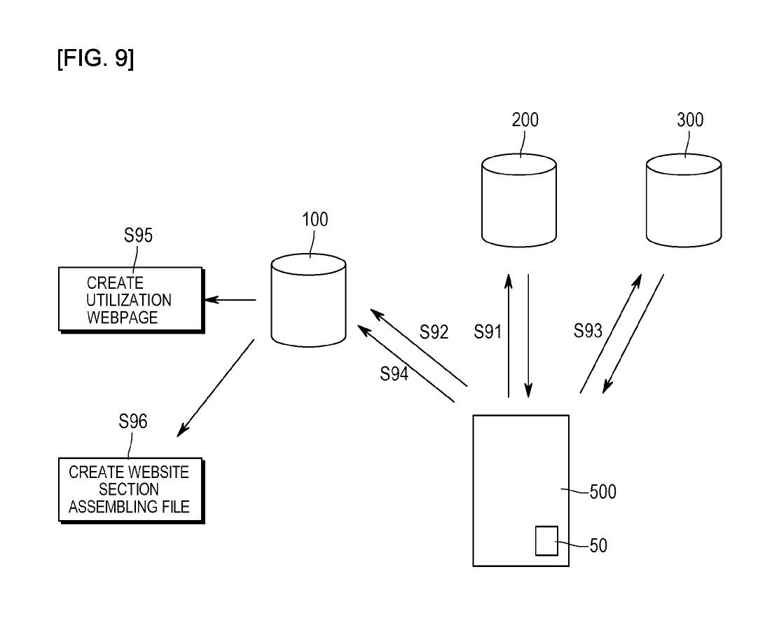

FIG. 9 is a view showing another embodiment of creating a website-section assembling file.

First, the user computer 500 connects to the utilization website 200, and accordingly, a webpage of the utilization website 200 is outputted on the user computer 500 (Step S91).

The user computer 500 establishes a section to be utilized on the outputted webpage of the utilization website 200 by means of the input means, and the website-section assembling apparatus 50 or the web browser installed in the user computer 500 reads the URL of the webpage containing the established utilization-section of the utilization website (the utilization URL) and position value of the established utilization-section and transmits the utilization-section information to the website-section assembling server 100 (Step S92).

Next, the user computer 500 connects to the target website 300 through the Internet 800, and a webpage of the target website 300 is outputted on the user computer 500 (Step S93).

The website-section assembling apparatus 50 of the user computer 500 reads the URL of the webpage of the target website 300 (hereinafter, referred to as a target URL) and transmits the target URL to the website-section assembling server 100 (Step S94).

Next, the website-section assembling server 100 creates a utilization webpage which outputs the utilization-section of the webpage of the utilization website by the size of the utilization-section according to the received utilization-section information (Step S95). Such a utilization webpage can be created in the same way as shown in the first and second embodiments described above.

In this case, the website-section assembling server 100 preferably stores the utilization URL and the position value of the utilization-section or URL of the utilization webpage in a database in relation with the target URL.

Next, the website-section assembling server 100 creates a website-section assembling file (Step S96).

The website-section assembling file is the thing which is executed to output the utilization-section of the webpage of the utilization website on the output display of the webpage of the target website according to the utilization URL when the user computer having a web browser connects to the target URL.

For example, the website-section assembling file records the utilization URL and the target URL, and program sentence which is executed to output the utilization-section of the webpage of the utilization website on the output display of the webpage of the target website corresponding to the target URL when the user computer having a web browser connects to the target URL.

In other case, it can record program sentence which inquires the utilization URL and the target URL to the website-section assembling server 100 without recording those values.

Such program sentence can be written in a script, CSS or the like.

The program sentence may output the utilization-section of the webpage of the utilization website on the output display of the webpage of the target website according to the target URL in the same way as shown in embodiments described above. In addition, the utilization-section can be outputted at the target position specified by the user or at a predetermined specific position, or at a random position and moved to a certain position by dragging a mouse.

As described above, the website-section assembling server 100 creates the website-section assembling file and the user computer to which the website-section assembling file is transferred or the user computer sharing the website-section assembling file can make the utilization-section of the webpage of the utilization website outputted on the output display of the webpage of the target website corresponding to the target URL by executing it although the user computer does not have the website-section assembling apparatus 50.

Meanwhile, according to the present invention, if a utilization-section desired to be utilized is established by means of an input device on the display of the webpage outputted when the user computer connects to the utilization website, the website-section assembling apparatus 50 or a web browser reads utilization URL that is the URL of the webpage of the utilization website and position value of the established utilization-section and transmits the utilization URL and the position value to the website-section assembling server 100, then, the website-section assembling server 100 stores the utilization URL and the position value of the established utilization-section in a database and creates a utilization-section output file which is executed to output the utilization-section of the webpage of the utilization website on the output display of the webpage to which the computer having a web browser connects according to the utilization URL and the position value of the established utilization-section.

After creating the utilization-section output file, if a webpage of the target website to which the utilization section is assembled is defined, a website-section assembling file which is executed to output the utilization section of the utilization website on the output webpage of the target website according to the utilization URL and the position value of the utilization section when the user computer having the web browser connects to the target URL can be created by combining the utilization-section output file with the target URL that is the URL of the webpage of the target website.

The URL of the webpage of the target website can be directly inputted into the user computer 500 by the user and transmitted to the website-section assembling server 100, or the URL of a webpage of a specific website to which the user computer 500 is connected can be transmitted to the website-section assembling server 100 as a target URL.

On the other hand, the website-section assembling server 100 creates a utilization webpage which outputs the utilization-section of the webpage of the utilization website by the size of the utilization-section according to the utilization URL and the position value of the utilization section, and create a utilization-section output file which is executed to output the utilization-section of the webpage of the utilization website according to the URL of the utilization webpage on the output display of the target URL when the user computer having a web browser connects to the target URL.

After creating the utilization-section output file, if a webpage of the target website to which the utilization section is assembled is defined, a website-section assembling file which is executed to output the utilization section of the utilization website on the output webpage of the target website according to the utilization URL and the position value of the utilization section when the user computer having the web browser connects to the target URL can be created by combining the utilization-section output file with the target URL that is the URL of the webpage of the target website.

As described above, although the website-section assembling apparatus 50 is not installed in the user computer, a utilization-section is outputted on the webpage of the target website as it is assembled thereinto by executing the website-section assembling file. The website-section assembling apparatus 50 functions as a web editor for creating a file for easily assembling a website without an effort of programming by a user.

As described above, in the present invention, a section established as a utilization-section in a webpage of the utilization website 200 is outputted on a webpage of the target website 300, and the utilization-section of the utilization website operates as if it is a part of the target website. These settings can be stored and used whenever a user visits the target website.

In addition, program sentence created by a user or a source code of another website can be registered in the website-section assembling server, and a section of a webpage can be outputted on a webpage of a desired target website as it is assembled therein.

Furthermore, a website-section assembling file is created, and thus although the website-section assembling apparatus 50 is not installed in a user computer, a section of a website can be outputted on the target webpage as it is assembled thereinto.

While the present invention has been described with reference to the particular illustrative embodiments, it is not to be restricted thereby.

We claim:

1.-65. (canceled)

66. In a website-section assembling system including a utilization website of which a section of a webpage is desired to be utilized by a user, a target website on an output display of a webpage of which the section of the webpage of the utilization website is desired to be outputted as it is assembled therein, a user computer having a web browser and a website-section assembling apparatus, and a website-section assembling server, a method for assembling the section of the webpage of the utilization website in the output display of the webpage of the target website comprising the steps of:
(a) a utilization-section information transmission step wherein if a utilization-section that is the section of the webpage of the utilization website desired to be utilized is established by means of an input device on the display of the webpage of the utilization website outputted in the user computer when the user computer connects to the utilization website, the website-section assembling apparatus or the web browser reads utilization URL that is the URL of the webpage of the utilization website and position value of the established utilization-section and transmits the utilization URL and the position value to the website-section assembling server;
(b) a utilization-section information store step wherein the website-section assembling server receives the utilization-section information and stores it;
(c) a utilization-section information request step wherein the user computer connects to the target website and the website-section assembling apparatus in the user computer requests the utilization-section information to the website-section assembling server; and
(d) a utilization-section output step wherein the website-section assembling apparatus reads the utilization-section information and outputs the utilization-section of the webpage of the utilization website on the output display of the webpage of the target website in the user computer if the website-section assembling server transmits the utilization-section information to the user computer according to the utilization-section information request.

67. The method for assembling the section of the webpage of the utilization website in the output display of the webpage of the target website as claimed in claim 66, wherein a target position that is a position where the utilization-section is desired to be outputted is set by means of the input device on the display of the webpage outputted in the user computer when the user computer connects to the target website, and the website-section assembling apparatus reads target position value and outputs the utilization-section at the target position.

68. The method for assembling the section of the webpage of the utilization website in the output display of the webpage of the target website as claimed in claim 66, wherein the utilization-section is outputted at a position according to the predetermined position value set in the website-section assembling apparatus or the website-section assembling server or at a random position, and the outputted utilization-section can be moved by handling the input device of the user computer.

69. The method for assembling the section of the webpage of the utilization website in the output display of the webpage of the target website as claimed in claim 68, wherein the outputted utilization-section is moved to a position desired by the user on the output display of the target website by dragging the input device connected to the user computer.

70. The method for assembling the section of the webpage of the utilization website in the output display of the webpage of the target website as claimed in claim 66 wherein in the utilization-section output step, the website-section assembling apparatus creates a layer at the output position of the utilization-section on the outputted webpage of the target website and injects the utilization URL into the layer so that the utilization URL is called.

71. The method for assembling the section of the webpage of the utilization website in the output display of the webpage of the target website as claimed in claim 70, wherein the layer is created to have a size of the utilization-section and output of the webpage according to the utilization URL at the layer is adjusted to the position of the utilization-section.

72. The method for assembling the section of the webpage of the utilization website in the output display of the webpage of the target website as claimed in claim 71, wherein in the utilization-section output step, the website-section assembling apparatus creates the layer having the size of the utilization-section at the output position of the utilization-section on the webpage of the target website by means of a div tag and injects an iframe tag to the layer so that the utilization URL is called, and at this point, a position of a scroll bar in the URL called in the iframe is adjusted to a top-left coordinate value of the utilization-section position value.

73. The method for assembling the section of the webpage of the utilization website in the output display of the webpage of the target website as claimed in claim 72, wherein VISUAL among attributes of the scroll bar is set to NO so that the scroll bar is not shown.

74. The method for assembling the section of the webpage of the utilization website in the output display of the webpage of the target website as claimed in claim 66, wherein in the utilization-section output step a new window is created at the output position of the utilization-section on the output display of the webpage of the target website and a browser is outputted in the new window and, at this point, the utilization URL is called in the browser to output display according to the URL.

75. The method for assembling the section of the webpage of the utilization website in the output display of the webpage of the target website as claimed in claim 66, wherein in the utilization-section output step, the website-section assembling apparatus selectively performs a step of creating a new window at the output position of the utilization-section on the output display of the webpage of the target website, outputting the web browser in the new window, and calling the utilization URL in the web browser to output display according to the URL or a step of creating a layer at the output position of the utilization-section on the outputted webpage of the target website and injecting the utilization URL to the layer so that the utilization URL is called.

76. In a website-section assembling system including a utilization website of which a section of a webpage is desired to be utilized by a user, a target website on an output display of a webpage of which the section of the webpage of the utilization website is desired to be outputted as it is assembled therein, a user computer having a web browser and a website-section assembling apparatus, and a website-section assembling server, a method for assembling the section of the webpage of the utilization website in the output display of the webpage of the target website comprising the steps of:
(a) a utilization-section information transmission step wherein the website-section assembling apparatus or the web browser installed in the user computer reads inputted utilization URL that is the URL of the webpage of the utilization website and position value of a utilization-section of the webpage of the utilization website and transmits the utilization URL and the position value to the website-section assembling server;
(b) a utilization-section information store step wherein the website-section assembling server receives the utilization-section information and stores it;
(c) a utilization-section information request step wherein the user computer connects to the target website and the website-section assembling apparatus in the user computer requests the utilization-section information to the website-section assembling server; and
(d) a utilization-section output step wherein the website-section assembling apparatus reads the utilization-section information and outputs the utilization-section of the webpage of the utilization website on the output display of the webpage of the target website in the user computer if the website-section assembling server transmits the utilization-section information to the user computer according to the utilization-section information request.

77. The method for assembling the section of the webpage of the utilization website in the output display of the webpage of the target website as claimed in claim 76, wherein in the utilization-section information transmission step, an input window is outputted to the user computer when the user computer connects to the website-section assembling server, and if the utilization-section information is inputted to the input window, the website-section assembling apparatus reads the inputted utilization-section information and transmits it to the website-section assembling server.

78. The method for assembling the section of the webpage of the utilization website in the output display of the webpage of the target website as claimed in claim 76, wherein if the position value of the utilization-section is not inputted in the utilization-section information transmission step, the entire webpage of the utilization website is determined and stored as the utilization-section in the utilization-section information store step.

79. In a website-section assembling system including a utilization website of which a section of a webpage is desired to be utilized by a user, a target website on an output display of a webpage of which the section of the webpage of the utilization website is desired to be outputted as it is assembled therein, a user computer having a web browser and a website-section assembling apparatus, and a website-section assembling server, a method for assembling the section of the webpage of the utilization website in the output display of the webpage of the target website comprising the steps of:
(a) a utilization-section information transmission step wherein if a utilization-section that is the section of the webpage of the utilization website desired to be utilized is established by means of an input device on the display of the webpage of the utilization website outputted in the user computer when the user computer connects to the utilization website, the website-section assembling apparatus or the web browser reads utilization URL that is the URL of the webpage of the utilization website and position value of the established utilization-section and transmits the utilization URL and the position value to the website-section assembling server;
(b) a utilization-section information store step wherein the website-section assembling server receives the utilization-section information and stores it;
(c) a target URL transmission step wherein the website-section assembling apparatus in the user computer reads target URL that is the URL of the webpage of the target website and transmits the target URL to the website-section assembling server;
(d) a target URL store step wherein the website-section assembling server receives the target URL and stores it in relation with the utilization-section information;
(e) a utilization-section information request step wherein the user computer connects to the webpage of the target website, and the website-section assembling apparatus requests the utilization-section information in relation with the target URL to the website-section assembling server; and
(f) a utilization-section output step wherein the website-section assembling apparatus reads the utilization-section information and outputs the utilization-section of the webpage of the utilization website on the output display of the webpage of the target website in the user computer if the website-section assembling server transmits the utilization-section information to the user computer according to the utilization-section information request.

80. The method for assembling the section of the webpage of the utilization website in the output display of the webpage of the target website as claimed in claim 79, wherein the target URL transmission step is a target section information transmission step wherein, if a target position that is a position where the utilization-section is desired to be outputted is set by means of the input device on the output display of the webpage of the target website outputted in the user computer when the user computer connects to the target website, the website-section assembling apparatus reads the target position value and the target URL and transmits them to the website-section assembling server; the target URL store step is a target section information store step wherein the website-section assembling server receives the target section information and stores it; the utilization-section information request step is a section information request step wherein the website-section assembling apparatus requests the target position and the utilization-section information to the website-section assembling server; and the utilization-section output step is a target position output step wherein the website-section assembling apparatus outputs the utilization-section of the webpage of the utilization website at the target position on the output display of the webpage of the target website.

81. The method for assembling the section of the webpage of the utilization website in the output display of the webpage of the target website as claimed in claim 79, wherein the utilization-section is outputted at a position according to the predetermined position value set in the website-section assembling apparatus or the website-section assembling server or at a random position, and the outputted utilization-section can be moved by handling the input device of the user computer.

82. The method for assembling the section of the webpage of the utilization website in the output display of the webpage of the target website as claimed in claim 81, wherein the outputted utilization-section is moved to a position desired by the user on the output display of the target website by dragging a mouse connected to the user computer.

83. The method for assembling the section of the webpage of the utilization website in the output display of the webpage of the target website as claimed in claim 79, wherein in the utilization-section output step, the website-section assembling apparatus creates a layer at the target position on the outputted webpage of the target website and injects the utilization URL into the layer so that the utilization URL is called.

84. The method for assembling the section of the webpage of the utilization website in the output display of the webpage of the target website as claimed in claim 83, wherein the layer is created to have a size of the utilization-section and output of the webpage according to the utilization URL at the layer is adjusted to the position of the utilization-section.

85. The method for assembling the section of the webpage of the utilization website in the output display of the webpage of the target website as claimed in claim 84, wherein, in the utilization-section output step, the website-section assembling apparatus creates the layer having the size of the utilization-section at the output position of the utilization-section on the webpage of the target website by means of a div tag and injects an iframe tag to the layer so that the utilization URL is called, and at this point, a position of a scroll bar in the URL called in the iframe is adjusted to a top-left coordinate value of the utilization-section position value.

86. The method for assembling the section of the webpage of the utilization website in the output display of the webpage of the target website as claimed in claim 85, wherein VISUAL among attributes of the scroll bar is set to NO so that the scroll bar is not shown.

87. The method for assembling the section of the webpage of the utilization website in the output display of the webpage of the target website as claimed in claim 79, wherein in the utilization-section output step a new window is created at the output position of the utilization-section on the output display of the webpage of the target website and a browser is outputted in the new window and, at this point, the utilization URL is called in the browser to output display according to the URL.

88. The method for assembling the section of the webpage of the utilization website in the output display of the webpage of the target website as claimed in claim 79, wherein in the utilization-section output step, the website-section assembling apparatus selectively performs a step of creating a new window at the output position of the utilization-section on the output display of the webpage of the target website, outputting the web browser in the new window, and calling the utilization URL in the web browser to output display according to the URL or a step of creating a layer at the output position of the utilization-section on the outputted webpage of the target website and injecting the utilization URL to the layer so that the utilization URL is called.

89. In a website-section assembling system including a utilization website of which a section of a webpage is desired to be utilized by a user, a target website on an output display of a webpage of which the section of the webpage of the utilization website is desired to be outputted as it is assembled therein, a user computer having a web browser and a website-section assembling apparatus, and a website-section assembling server, a method for assembling the section of the webpage of the utilization website in the output display of the webpage of the target website comprising the steps of:
(a) a utilization-section information transmission step wherein if a utilization-section that is the section of the webpage of the utilization website desired to be utilized is established by means of an input device on the display of the webpage of the utilization website outputted in the user computer when the user computer connects to the utilization website, the website-section assembling apparatus or the web browser reads utilization URL that is the URL of the webpage of the utilization website and position value of the established utilization-section and transmits the utilization URL and the position value to the website-section assembling server;
(b) a target URL transmission step wherein the website-section assembling apparatus in the user computer reads target URL that is the URL of the webpage of the target website and transmits the target URL to the website-section assembling server;
(c) a utilization webpage creation step wherein the website-section assembling server creates a utilization webpage that is a webpage which outputs the utilization-section of the webpage of the utilization website by the size of the utilization-section according to the received utilization-section information;
(d) a target URL store step wherein the website-section assembling server receives the target URL and stores it in relation with the utilization-section information or the URL of the utilization webpage;
(e) a target URL connection step wherein the user computer connects to the webpage of the target website, and the website-section assembling apparatus informs the website-section assembling server of the target URL; and
(f) a utilization-section output step wherein if the website-section assembling server transmits the URL of the utilization webpage to the user computer, the website-section assembling apparatus creates a layer at an output position on the webpage of the target website and injects the URL of the utilization webpage into the layer to call the utilization webpage to output the utilization-section of the webpage of the utilization website at the output position on the output display of the webpage of the target website.

90. The method for assembling the section of the webpage of the utilization website in the output display of the webpage of the target website as claimed in claim 89, wherein the website-section assembling server transmits information of the size of the utilization-section to the user computer as well as the URL of the utilization webpage, and the layer is created by the size of the utilization-section.

91. The method for assembling the section of the webpage of the utilization website in the output display of the webpage of the target website as claimed in claim 89, wherein, in the utilization webpage creation step, the website-section assembling server creates a layer having the size of the utilization-section at the top-left (0, 0) position and injects the utilization URL to the layer to call the utilization URL, and the output of the called webpage in the layer is adjusted to the position of the utilization section.

92. The method for assembling the section of the webpage of the utilization website in the output display of the webpage of the target website as claimed in claim 91, wherein, in the utilization webpage creation step, the website-section assembling server creates the layer having the size of the utilization-section at the top-left (0, 0) position by using a div tag, injects iframe tag into the layer to call the utilization URL and, in the output display of the URL called in the iframe, the position of a scroll bar is set to top left coordinate value of the position value of the utilization section.

93. The method for assembling the section of the webpage of the utilization website in the output display of the webpage of the target website as claimed in claim 92, wherein VISUAL among attributes of the scroll bar is set to NO so that the scroll bar is not shown.

94. The method for assembling the section of the webpage of the utilization website in the output display of the webpage of the target website as claimed in claim 93, wherein in the utilization-section output step, the website-section assembling apparatus creates a layer at the output position of the output display of the webpage according to the target URL adjusted to the size of the utilization-section by means of a div tag and injects an iframe tag to the layer so that the URL of the utilization webpage is called.

95. The method for assembling the section of the webpage of the utilization website in the output display of the webpage of the target website as claimed in claim 89, wherein the utilization webpage is temporarily created.

96. The method for assembling the section of the webpage of the utilization website in the output display of the webpage of the target website as claimed in claim 89, wherein the website-section assembling apparatus is integrated to the web browser installed in the user computer.

97. In a website-section assembling system including a utilization website of which a section of a webpage is desired to be utilized by a user, a target website on an output display of a webpage of which the section of the webpage of the utilization website is desired to be outputted as it is assembled therein, a user computer having a web browser and a website-section assembling apparatus, and a website-section assembling server, a method for assembling the section of the webpage of the utilization website in the output display of the webpage of the target website comprising the steps of:
(a) a utilization-section information transmission step wherein the website-section assembling apparatus or the web browser installed in the user computer reads utilization URL that is the URL of the webpage of the utilization website inputted into the user computer and position value of a utilization-section of the webpage of the utilization website and transmits the utilization URL and the position value to the website-section assembling server;
(b) a utilization-section information store step wherein the website-section assembling server receives the utilization-section information and stores it;
(c) a target URL transmission step wherein the website-section assembling apparatus of the user computer reads target URL that is the URL of the webpage of the target website and transmits the target URL to the website-section assembling server;
(d) a target URL store step wherein the website-section assembling server receives the target URL and stores it in relation with the utilization-section information;
(e) a utilization-section information request step wherein the user computer connects to the webpage of the target website, and the website-section assembling apparatus requests the utilization-section information in relation with the target URL from the website-section assembling server; and
(f) a utilization-section output step wherein the website-section assembling apparatus reads the utilization-section information and outputs the utilization-section of the webpage of the utilization website on the output display of the webpage of the target website if the website-section assembling server transmits the utilization-section information to the user computer according to the utilization-section information request.

98. The method for assembling the section of the webpage of the utilization website in the output display of the webpage of the target website as claimed in claim 97, wherein in the utilization-section information transmission step, an input window is outputted on the user computer when the user computer connects to the website-section assembling server, and if the utilization-section information is inputted into the input window, the website-section assembling apparatus reads the inputted utilization-section information and transmits it to the website-section assembling server.

99. The method for assembling the section of the webpage of the utilization website in the output display of the webpage of the target website as claimed in claim 97 wherein if the position value of the utilization-section is not inputted in the utilization-section information transmission step, the entire webpage of the utilization website is determined and stored as the utilization-section in the utilization-section information store step.

100. The method for assembling the section of the webpage of the utilization website in the output display of the webpage of the target website as claimed in claim 97, wherein the utilization URL includes a source path.

101. The method for assembling the section of the webpage of the utilization website in the output display of the webpage of the target website as claimed in claim 100, further comprising the step of a utilization webpage creation step wherein the website-section assembling server creates a utilization webpage that is a webpage which outputs the utilization-section of the webpage of the utilization website by the size of the utilization-section; wherein the utilization-section output step is that, if the website-section assembling server transmits URL of the utilization webpage to the user computer, the website-section assembling apparatus creates a layer at an output position on the webpage of the target website and injects the URL of the utilization webpage into the layer to call the utilization webpage so that the utilization-section of the webpage of the utilization website is outputted at the output position on the webpage of the target website.

102. The method for assembling the section of the webpage of the utilization website in the output display of the webpage of the target website as claimed in claim 101, wherein the website-section assembling server transmits information on the size of the utilization-section to the user computer together with the URL of the utilization webpage, and the creation of the layer is made according to the size of the utilization-section.

103. The method for assembling the section of the webpage of the utilization website in the output display of the webpage of the target website as claimed in claim 102, wherein in the utilization webpage creation step, the website-section assembling server creates the layer at a top-left (0, 0) position by the size of the utilization-section and injects the utilization URL to call the utilization URL, and the webpage called in the layer is adjusted to the position of the utilization-section.

104. The method for assembling the section of the webpage of the utilization website in the output display of the webpage of the target website as claimed in claim 103, wherein, in the utilization webpage creation step, the website-section assembling server creates the layer having the size of the utilization-section at the top-left (0, 0) position by using a div tag and injects an iframe tag into the layer to call the utilization URL, and at this point, a position of a scroll bar on a webpage according to the URL called in the iframe is set to a top-left coordinate value of the utilization-section position value.

105. The method for assembling the section of the webpage of the utilization website in the output display of the webpage of the target website as claimed in claim 104, VISUAL among attributes of the scroll bar is set to NO so that the scroll bar is not shown.

106. In a website-section assembling system including a target website on an output display of a webpage of which a specific display is desired to be outputted as it is assembled therein, a user computer having a web browser and a website-section assembling apparatus, and a website-section assembling server, a method for assembling a specific display in the output display of the webpage of the target website comprising the steps of:
(a) a program sentence transmission step wherein the website-section assembling apparatus or the web browser installed in the user computer is inputted program sentence configuring the specific display and transmits the program sentence to the website-section assembling server;
(b) a utilization webpage creation step wherein the website-section assembling server receives the program sentence and creates a utilization webpage that is a webpage which outputs the display according to the program sentence;
(c) a target URL transmission step wherein the website-section assembling apparatus in the user computer reads target URL that is the URL of the webpage of the target website and transmits the target URL to the website-section assembling server;
(d) a target URL store step wherein the website-section assembling server receives the target URL and stores it in relation with the URL of the utilization webpage or the program sentence;
(e) a utilization webpage request step wherein the user computer connects to the webpage of the target website, and the website-section assembling apparatus requests URL of the utilization webpage in relation with the target URL to the website-section assembling server; and
(f) a specific display output step wherein if the website-section assembling server transmits the URL of the utilization webpage to the user computer according to the utilization webpage request step, the website-section assembling apparatus reads the URL of the utilization webpage and outputs the specific display on the output display of the webpage of the target website.

107. The method for assembling a specific display in the output display of the webpage of the target website as claimed in claim 106 wherein the program sentence configuring the specific display is written in html, object code, or script.

108. In a website-section assembling system including a target website on an output display of a webpage of which a specific display is desired to be outputted as it is assembled therein, a user computer having a web browser and a website-section assembling apparatus, and a website-section assembling server, a method for assembling a specific display in the output display of the webpage of the target website performed by the website-section assembling server comprising the steps of:
(a) a utilization webpage creation step which, if the website-section assembling apparatus or the web browser installed in the user computer is inputted program sentence configuring the specific display and transmits the program sentence to the website-section assembling server, creates a utilization webpage that is a webpage that outputs the specific display according to the program sentence;
(b) a target URL store step which, if the website-section assembling apparatus in the user computer reads target URL that is the URL of the webpage of the target website and transmits the target URL, stores the target URL in relation with the URL of the utilization webpage or the program sentence; and
(c) a utilization webpage URL transmission step which, if the user computer connects to the webpage of the target website and the website-section assembling apparatus requests URL of the utilization webpage in relation with the target URL to the website-section assembling server, transmits the URL of the utilization webpage to the user computer; whereby the website-section assembling apparatus reads the URL of the utilization webpage and outputs the specific display on the output display of the webpage of the target website.

109. In a website-section assembling system including a target website on an output display of a webpage of which a specific display is desired to be outputted as it is assembled therein, a user computer having a web browser and a website-section assembling apparatus, and a website-section assembling server, a method for assembling a specific display in the output display of the webpage of the target website performed by the website-section assembling apparatus comprising the steps of:
(a) a display configuration program sentence transmission step which reads program sentence configuring the specific display inputted to the user computer and transmits the program sentence to the website-section assembling server; thereby the website-section assembling server receiving the program sentence and creating a utilization webpage that is a webpage which outputs the specific display according to the program sentence;
(b) a target URL transmission step which reads target URL that is the URL of the webpage of the target website and transmits the target URL to the website-section assembling server; thereby the website-section assembling server receiving the target URL and storing it in relation with the URL of the utilization webpage or the program sentence;
(c) a utilization webpage request step which, if the user computer connects to the webpage of the target website, requests URL of the utilization webpage in relation with the target URL to the website-section assembling server; and
(d) a specific display output step which, if the website-section assembling server transmits the URL of the utilization webpage to the user computer according to the utilization webpage request step, reads the URL of the utilization webpage and outputs the specific display on the output display of the webpage of the target website.

110. In a website-section assembling system including a utilization website of which a section of a webpage is desired to be utilized by a user, a target website on an output display of a webpage of which the section of the webpage of the utilization website is desired to be outputted as it is assembled therein, a user computer having a web browser and a website-section assembling apparatus, and a website-section assembling server, a method for assembling the section of the webpage of the utilization website in the output display of the webpage of the target website performed by the website-section assembling apparatus comprising the steps of:
(a) a utilization-section information transmission step which, if a utilization-section that is the section of the webpage of the utilization website desired to be utilized is established by means of an input device on the display of the webpage of the utilization website outputted in the user computer when the user computer connects to the utilization website, reads utilization URL that is the URL of the webpage of the utilization website and position value of the established utilization-section and transmits the utilization URL and the position value to the website-section assembling server;
(b) a target URL transmission step which reads target URL that is the URL of the webpage of the target website and transmits the target URL to the website-section assembling server; wherein the website assembling server creates a utilization webpage that is a webpage which outputs the utilization section of the webpage of the utilization website by the size of the utilization section according to the transmitted utilization section information; wherein the website assembling server is transmitted the target URL and stores it in relation with the utilization section information or the URL of the utilization webpage;
(c) a target URL connection step which, if the user computer connects to the webpage of the target website, informs the website-section assembling server of the target URL; and
(d) a utilization-section output step which, if the website-section assembling server transmits the URL of the utilization webpage to the user computer, creates a layer at an output position on the webpage of the target website and injects the URL of the utilization webpage into the layer to call the utilization webpage so that the utilization-section of the webpage of the utilization website is outputted at the output position on the output display of the webpage of the target website.

111. A method for creating a file for assembling website-section performed by an apparatus for creating a file for assembling website-section installed in a user computer to a utilization website of which a section of a webpage is desired to be utilized by a user and a target website on an output display of a webpage of which the section of the webpage of the utilization website is desired to be outputted as it is assembled therein, the method comprising the steps of:
(a) if a utilization-section that is the section of the webpage of the utilization website desired to be utilized is established by means of an input device on the display of the webpage of the utilization website outputted in the user computer when the user computer connects to the utilization website, reading utilization URL that is the URL of the webpage of the utilization website and position value of the established utilization-section;
(b) reading target URL that is the URL of the webpage of the target website at which the section of the webpage of the utilization website is desired to be outputted as it is assembled therein; and
(c) creating the file for assembling website-section, the file being executed to output the utilization-section of the webpage of the utilization website on the output display of the webpage of the target website according to the target URL according to the utilization URL and the position value of the utilization-section when the user computer having the web browser connects to the target URL.

112. In a website-section assembling system including a utilization website of which a section of a webpage is desired to be utilized by a user, a target website on an output display of a webpage of which the section of the webpage of the utilization website is desired to be outputted as it is assembled therein, a user computer having a web browser and a website-section assembling apparatus, and a website-section assembling server, a method for creating a file for assembling website-section performed by the website-section assembling server comprising the steps of:
if a utilization-section that is the section of the webpage of the utilization website desired to be utilized is established by means of an input device on the display of the webpage of the utilization website outputted in the user computer when the user computer connects to the utilization website and the website-section assembling apparatus or the web browser reads a utilization URL that is the URL of the webpage of the utilization website and position value of the established utilization-section and transmits the utilization URL and the position value to the website-section assembling server, and if the website-section assembling apparatus reads a target URL that is the URL of the webpage of the target website and transmits the target URL to the website-section assembling server, creating the file for assembling website-section, the file being executed to output the utilization-section of the webpage of the utilization website on the output display of the webpage of the target website according to the utilization URL and the position value of the utilization-section when the user computer having the web browser connects to the target URL.

113. In a website-section assembling system including a utilization website of which a section of a webpage is desired to be utilized by a user, a target website on an output display of a webpage of which the section of the webpage of the utilization website is desired to be outputted as it is assembled therein, a user computer having a web browser and a website-section assembling apparatus, and a website-section assembling server, a method for creating a file for assembling website-section performed by the website-section assembling server comprising the steps of:
if a utilization-section that is the section of the webpage of the utilization website desired to be utilized is established by means of an input device on the display of the webpage of the utilization website outputted in the user computer when the user computer connects to the utilization website and the website-section assembling apparatus or the web browser reads a utilization URL that is the URL of the webpage of the utilization website and position value of the established utilization-section and transmits the utilization URL and the position value to the website-section assembling server, and if the website-section assembling apparatus reads a target URL that is the URL of the webpage of the target website and transmits the target URL to the website-section assembling server,
(a) creating a utilization webpage that is a webpage which outputs the utilization-section of the webpage of the utilization website by the size of the utilization-section according to the transmitted utilization-section information;
(b) creating the file for assembling website-section, the file being executed to output the utilization-section of the webpage of the utilization website on the output display of the webpage of the target website according to the utilization URL and the position value of the utilization-section when the user computer having the web browser connects to the target URL.

114. In a website-section assembling system including a utilization website of which a section of a webpage is desired to be utilized by a user, a user computer having a web browser and a website-section assembling apparatus, and a website-section assembling server, a method for creating a file for assembling website-section performed by the website-section assembling server comprising the steps of:
(a) if a utilization-section that is the section of the webpage of the utilization website desired to be utilized is established by means of an input device on the display of the webpage of the utilization website outputted in the user computer when the user computer connects to the utilization website and the website-section assembling apparatus or the web browser reads utilization URL that is the URL of the webpage of the utilization website and position value of the established utilization-section and transmits the utilization URL and the position value to the website-section assembling server, storing the utilization URL and the position value of the established utilization-section;
(b) creating a utilization-section output file executed to output the utilization-section of the webpage of the utilization website on the output display of a webpage of a website to which the user computer having the web browser connects according to the utilization URL and the position value of the utilization-section;
(c) if target URL that is the URL of a webpage of a website on which the utilization-section is outputted is inputted, combining the target URL with the utilization-section output file and creating the file for assembling website-section executed to output the utilization-section of the webpage of the utilization website on the output display of the webpage of the target website according to the utilization URL and the position value of the utilization-section when the user computer having the web browser connects to the target URL.

115. In a website-section assembling system including a utilization website of which a section of a webpage is desired to be utilized by a user, a user computer having a web browser and a website-section assembling apparatus, and a website-section assembling server, a method for creating a file for assembling website-section performed by the website-section assembling server comprising the steps of:
(a) if a utilization-section that is the section of the webpage of the utilization website desired to be utilized is established by means of an input device on the display of the webpage of the utilization website outputted in the user computer when the user computer connects to the utilization website and the website-section assembling apparatus or the web browser reads utilization URL that is the URL of the webpage of the utilization website and position value of the established utilization-section and transmits the utilization URL and the position value to the website-section assembling server, storing the utilization URL and the position value of the established utilization-section;
(b) creating a utilization webpage which outputs the utilization-section of the webpage of the utilization website by the size of the utilization-section according to utilization-section information;
(c) creating a utilization-section output file executed to output the utilization-section of the webpage of the utilization website on the output display of a webpage of a website to which the user computer having the web browser connects according to the utilization URL;
(d) if target URL that is the URL of a webpage of a website on which the utilization-section is outputted is inputted, combining the target URL with the utilization-section output file and creating the file for assembling website-section executed to output the utilization-section of the webpage of the utilization website on the output display of the webpage of the target website when the user computer having the web browser connects to the target URL.
